(19) United States
(12) Patent Application Publication
(10) Pub. No.: US 2016/0212677 A1
(43) Pub. Date: Jul. 21, 2016

(54) COMBINED WWAN AND WLAN SIGNAL PATH CALIBRATION

(71) Applicant: QUALCOMM Incorporated, San Diego, CA (US)

(72) Inventors: Kaushik Chakraborty, San Diego, CA (US); Soumya Das, San Diego, CA (US); Edwin Chongwoo Park, San Diego, CA (US)

(21) Appl. No.: 14/600,360

(22) Filed: Jan. 20, 2015

(51) Int. Cl. H04W 40/02; H04B 1/40

(52) U.S. Cl. CPC H04W 40/02; H04B 1/40; H04W 84/12

(57) ABSTRACT

A combined signal path in a UE may use portions of a WWAN transceiver and portions of a WLAN transceiver. The combined signal path may be a combined Tx signal path or a combined Rx signal path. The combined signal path in the UE may be calibrated. Calibration may involve using a feedback path, such as a WWAN feedback path, a WLAN feedback path, or a combination of both WWAN and WLAN feedback paths.

### BACKGROUND

1. Field of the Disclosure

The present disclosure, for example, relates to wireless communication systems, and more particularly to techniques for calibrating combined signal paths that use at least a portion of a wireless wide area network (WWAN) transceiver in combination with at least a portion of a wireless local area network (WLAN) transceiver.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, space and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of base stations or access points (APs), each simultaneously supporting communication for multiple communication devices, otherwise known as user equipments (UEs) or wireless stations (STAs). A base station or AP may communicate with UEs or STAs on downlink channels (e.g., for transmissions from a base station to a UE, or from an AP to a wireless station) and uplink channels (e.g., for transmissions from a UE to a base station, or from a wireless station to an AP). In some instances, a wireless station and a UE may be a same device (which may be generically referred to herein as a UE). Communication between a UE and a base station may use a wireless wide area network (WWAN), while communication between a UE and an AP may use a wireless local area network (WLAN). UEs typically include different WWAN and WLAN transceivers, each having corresponding receive (Rx) and transmit (Tx) chains. For example, a UE may have one or more Rx and Tx chains in a WWAN transceiver used for WWAN communications, and may also have one or more separate Rx and Tx chains in a WLAN transceiver used for WLAN communications.

Rx and Tx chains in WWAN and WLAN transceivers may be calibrated using corresponding WWAN and WLAN feedback signal paths. Thus, and for example, a WWAN Tx chain may be calibrated by transmitting a signal along the WWAN Tx chain and then routing the signal to a corresponding WWAN feedback Rx chain. Similarly, a WLAN Tx chain may be calibrated by transmitting a signal along the WLAN Tx chain and then routing the signal to a corresponding WLAN feedback Rx chain. WWAN and WLAN Rx chains may also be calibrated.

### SUMMARY

UEs that include multiple antennas and transceivers may also include one or more combined signal paths. The combined signal paths may use portions of different transceivers. For example, a combined signal path may use portions of a WWAN transceiver and portions of a WLAN transceiver. The combined signal path may be a combined Tx signal path or a combined Rx signal path. The combined signal paths in the UE may be calibrated. Calibration may involve using the entirety of or elements of a feedback path, such as a WWAN feedback path, a WLAN feedback path, or a combination of both WWAN and WLAN feedback paths. A signal may be routed to a feedback path through either an antenna path, a cable, a switch, and/or a coupler, for example.

In a first illustrative embodiment, a method for wireless communication is disclosed. The method may include routing a signal on a combined signal path that uses at least a portion of a WWAN transceiver in combination with at least a portion of a WLAN transceiver. The method may also include calibrating at least a portion of the combined signal path. The combined signal path may include one of a combined transmission signal path or a combined receive signal path. Alternatively, the combined signal path may include a combined transmission signal path and a combined receive signal path.

In one aspect, the calibrating of at least the portion of the combined signal path may further include routing the signal to a feedback path of either the WWAN transceiver or the WLAN transceiver. Alternatively, the calibrating of at least the portion of the combined signal path may further include routing the signal to a feedback path of the WWAN transceiver and a feedback path of the WLAN transceiver.

In an aspect, the calibrating of at least the portion of the combined signal path may further include routing the signal to a calibration unit. In another aspect, the calibrating of at least the portion of the combined signal path may further include calibrating a plurality of combined signal paths that each use portions of the WWAN transceiver in combination with portions of the WLAN transceiver. In yet another aspect, the calibrating of at least the portion of the combined signal path may further include routing the signal to a plurality of feedback paths corresponding to a plurality of receive chains associated with either the WWAN or the WLAN transceiver.

In one aspect, the combined signal path may include at least portions of a digital baseband chain and analog baseband chain of the WWAN transceiver and at least portions of an analog radio frequency (RF) chain of the WLAN transceiver. In this aspect, calibrating at least the portion of the combined signal path may further include connecting an output of the combined signal path with a feedback path of the WLAN transceiver and using the feedback path of the WLAN transceiver. The calibrating of at least the portion of the combined signal path may further include calibrating the combined signal path at a WLAN digital baseband chain.

In the aspect where the combined signal path may include at least portions of a digital baseband chain and analog baseband chain of the WWAN transceiver and at least portions of an analog RF chain of the WLAN transceiver, the calibrating of at least the portion of the combined signal path may further include connecting an output of the combined signal path with a feedback path of the WWAN transceiver and using the feedback path of the WWAN transceiver. The calibrating of at least the portion of the combined signal path may further include calibrating the combined signal path at the WWAN digital baseband chain.

The calibrating of at least the portion of the combined signal path may further include connecting an output of the combined signal path with a feedback path of the WLAN transceiver, connecting the output of the combined signal path with a feedback path of the WWAN transceiver, and using the feedback paths of the WWAN transceiver and of the WLAN transceiver. The method may further include calibrating at least the portion of the combined signal path at the WWAN digital baseband chain and at a WLAN digital baseband chain.

In an aspect, the calibrating of the combined signal path may further include receiving the signal at either the WWAN transceiver or the WLAN transceiver after an over the air transmission of the signal, and using the feedback paths of either the WWAN transceiver or the WLAN transceiver. The calibrating of at least the portion of the combined signal path may further include receiving the signal at the WWAN transceiver and the WLAN transceiver after an over the air transmission of the signal, and using the feedback paths of the WWAN transceiver and the WLAN transceiver. Additionally, the calibrating of at least the portion of the combined signal path may further include receiving the signal at either the WWAN transceiver or the WLAN transceiver via a cable crossover from an output of the combined signal path to either an input of the WWAN transceiver or an input of the WLAN transceiver, and using the feedback path of either the WWAN transceiver or the WLAN transceiver. The calibrating of at least the portion of the combined signal path may further include receiving the signal at the WWAN transceiver and the WLAN transceiver via a cable from an output of the combined signal path to an input of the WWAN transceiver and an input of the WLAN transceiver, and using the feedback path of the WWAN transceiver and the WLAN transceiver.

In another aspect, the combined signal path may include at least portions of a digital baseband chain and analog baseband chain of the WLAN transceiver and at least portions of an analog RF chain of the WWAN transceiver.

The calibrating of at least the portion of the combined signal path may further include calibrating at least portions of a plurality of combined signal paths that each use portions of the WWAN transceiver in combination with portions of the WLAN transceiver. At least a first one of the plurality of combined signal paths may include at least portions of a digital baseband chain and analog baseband chain of the WWAN transceiver and at least portions of an analog RF chain of the WLAN transceiver, and at least a second one of the plurality of combined signal paths may include at least portions of a digital baseband chain and analog baseband chain of the WLAN transceiver and at least portions of an analog RF chain of the WWAN transceiver. In another aspect, the calibrating of at least the portion of the combined signal path may further include routing the signal to one or more feedback paths of the WWAN transceiver, and routing the signal to one or more feedback paths of the WLAN transceiver.

In a second illustrative embodiment, an apparatus for wireless communication is disclosed. The apparatus may include means for routing a signal on a combined signal path that uses at least a portion of a WWAN transceiver in combination with at least a portion of a WLAN transceiver, and means for calibrating at least a portion of the combined signal path. The means for calibrating at least the portion of the combined signal path may further include means for routing the signal to a feedback path of either the WWAN transceiver or the WLAN transceiver. Alternatively, the means for calibrating at least the portion of the combined signal path may further include means for routing the signal to a feedback path of the WWAN transceiver and a feedback path of the WLAN transceiver.

In an aspect, the means for calibrating at least the portion of the combined signal path may further include means for routing the signal to a calibration unit. In another aspect, the means for calibrating at least the portion of the combined signal path may further include means for calibrating a plurality of combined signal paths that each use portions of the WWAN transceiver in combination with portions of the WLAN transceiver. In yet another aspect, the means for calibrating at least the portion of the combined signal path may further include means for routing the signal to a plurality of feedback paths corresponding to a plurality of receive chains associated with either the WWAN or the WLAN transceiver.

In a third illustrative embodiment, an apparatus for wireless communication is disclosed. The apparatus may include a processor, memory in electronic communication with the processor, and instructions stored in the memory. The instructions may be executable by the processor to route a signal on a combined signal path that uses at least a portion of a WWAN transceiver in combination with at least a portion of a WLAN transceiver, and to calibrate at least a portion of the combined signal path.

In yet another illustrative embodiment, a non-transitory computer-readable medium storing computer-executable code for wireless communication is disclosed. The code may be executable by a processor to route a signal on a combined signal path that uses at least a portion of a WWAN transceiver in combination with at least a portion of a WLAN transceiver, and to calibrate at least a portion of the combined signal path.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a system diagram of a wireless communications system, in accordance with various aspects of the present disclosure;

FIGS. 2A and 2B show example calibration systems in a transceiver, in accordance with various aspects of the present disclosure;

FIG. 3 shows an example of a combined signal path using WWAN and WLAN transceivers, in accordance with various aspects of the present disclosure;

FIG. 4 shows an example of a combined signal path using WWAN and WLAN transceivers, in accordance with various aspects of the present disclosure;

FIGS. 5A and 5B show example calibration systems for combined signal paths using WWAN and WLAN transceivers, in accordance with various aspects of the present disclosure;

FIGS. 6A and 6B show example calibration systems for combined signal paths using WWAN and WLAN transceivers, in accordance with various aspects of the present disclosure;

FIGS. 7A and 7B show example calibration systems for combined signal paths using WWAN and WLAN transceivers, in accordance with various aspects of the present disclosure;

FIGS. 8A and 8B show example calibration systems for combined signal paths using WWAN and WLAN transceivers, in accordance with various aspects of the present disclosure;

FIG. 9 shows an example calibration system for a combined signal path using WWAN and WLAN transceivers, in accordance with various aspects of the present disclosure;

FIG. 10 shows a block diagram of an apparatus for use in wireless communication, in accordance with various aspects of the present disclosure;

FIG. 11 shows a block diagram of an apparatus for use in wireless communication, in accordance with various aspects of the present disclosure;

FIG. 12 shows a block diagram of a wireless device for use in wireless communication, in accordance with various aspects of the present disclosure; and

FIGS. 13-16 are flow charts illustrating examples of methods for wireless communication, in accordance with various aspects of the present disclosure.

### DETAILED DESCRIPTION

Many UEs include multiple antennas or transceivers so as to facilitate communications on different radio access technologies (RATs). In one example, a UE may include one or more WWAN antennas and may also include at least one WLAN antenna. The antennas may each be associated with corresponding transceivers that may each include Rx and Tx chains. Sometimes the WWAN Rx/Tx chains are used while the WLAN Rx/Tx chains are not being used or have capacity for additional use. Therefore, in some circumstances, at least portions of one or more WLAN Rx/Tx chains may be used to assist in WWAN operations. For example, a UE may be in a connected state using a WWAN (e.g., a Long-Term Evolution (LTE) network), thus using one or more WWAN Rx/Tx chains. Typically, this means that the one or more WWAN Rx/Tx chains are tuned to certain frequencies or frequency bands. However, while the UE uses the WWAN, the UE may also have need to search for cells or make measurements on frequencies that are different from those to which the WWAN Rx/Tx chains are tuned, for example, as in the case of inter-RAT searches. Thus, while the UE uses the WWAN Rx/Tx chains, the UE may also search for cells or make measurements using portions of the WLAN Rx/Tx chains. As another example, while a WWAN Rx/Tx chain in a UE may be used in association with a first subscriber identity module (SIM), portions of a WLAN Rx/Tx chain in the UE may be used in association with a second SIM during dual SIM dual active (DSDA) operations.

In these examples, an Rx or Tx signal path may use portions from both a WWAN transceiver and a WLAN transceiver. The combined signal paths in the UE may be calibrated. Calibration may involve using a feedback path, such as a WWAN feedback path, a WLAN feedback path, or a combination of both WWAN and WLAN feedback paths. Options for calibrating a combined signal path using the WWAN and WLAN feedback paths are described below.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

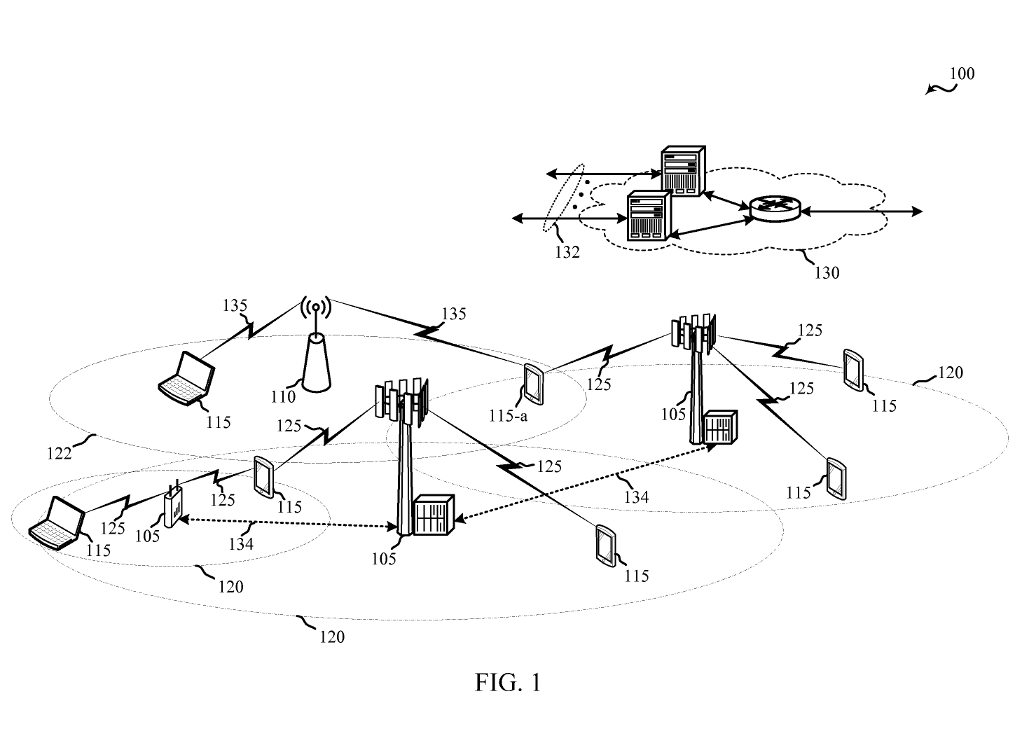

Referring first to FIG. 1, a system diagram illustrates an example of a wireless communications system 100. The wireless communications system 100 may include base station(s) 105, AP(s) 110, and mobile devices such as UEs 115. The UEs 115 may be examples of either UEs or wireless stations, or both, and are generically referred to herein as UEs. The AP 110 may provide wireless communications via a WLAN radio access network (RAN) such as, e.g., a network implementing at least one of the IEEE 802.11 family of standards. The AP 110 may provide, for example, Wi-Fi or other WLAN communications access to a UE 115. Each AP 110 has a geographic coverage area 122 such that UEs 115 within that area can typically communicate with the AP 110. UEs 115 may be multi-access mobile devices that communicate with the AP 110 and a base station 105 via different radio access networks. The UE 115, such as mobile stations, personal digital assistants (PDAs), other handheld devices, netbooks, notebook computers, tablet computers, laptops, display devices (e.g., TVs, computer monitors, etc.), printers, etc., may be stationary or mobile and traverse the geographic coverage areas 122 and/or 120, the geographic coverage area of a base station 105. While only one AP 110 is illustrated, the wireless communications system 100 may include multiple APs 110. Some or all of the UEs 115 may associate and communicate with an AP 110 via a communication link 135 and/or with a base station 105 via a communication link 125.

The wireless communications system 100 may also include a core network 130. The core network 130 may provide user authentication, access authorization, tracking, Internet Protocol (IP) connectivity, and other access, routing, or mobility functions. The base stations 105 interface with the core network 130 through backhaul links 132 (e.g., 51, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

A UE 115 can be covered by more than one AP 110 and/or base station 105 and can therefore associate with multiple APs 110 or base stations 105 at different times. For example, a single AP 110 and an associated set of UEs 115 may be referred to as a basic service set (BSS). An extended service set (ESS) is a set of connected BSSs. A distribution system (DS) (not shown) is used to connect APs 110 in an extended service set. A geographic coverage area 122 for an AP 110 may be divided into sectors making up only a portion of the geographic coverage area (not shown). The wireless communications system 100 may include APs 110 of different types (e.g., metropolitan area, home network, etc.), with varying sizes of coverage areas and overlapping coverage areas for different technologies. Although not shown, other wireless devices can communicate with the AP 110.

The base stations 105 may wirelessly communicate with the UEs 115 via base station antennas. Each of the base station 105 sites may provide communication coverage for a respective geographic coverage area 120. In some examples, base stations 105 may be referred to as a base transceiver station, a radio base station, an AP, a radio transceiver, a NodeB, evolved NodeB or eNodeB (eNB), Home NodeB, a Home eNodeB, or some other suitable terminology. The geographic coverage area 120 for a base station 105 may be divided into sectors making up only a portion of the coverage area (not shown). The wireless communications system 100 may include base stations 105 of different types (e.g., macro and/or small cell base stations). There may be overlapping geographic coverage areas 120/122 for different technologies.

In some examples, the wireless communications system 100 includes portions of an LTE or LTE-Advanced (LTE-A) network. In LTE/LTE-A networks, the term eNB may be generally used to describe the base stations 105, while the term UE may be generally used to describe the mobile devices (e.g., UEs 115). The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARM) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network supporting radio bearers for the user plane data. At the Physical (PHY) layer, the transport channels may be mapped to Physical channels.

The UEs 115 are dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a wireless station, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with various types of base stations and network equipment including macro eNBs, small cell eNBs, relay base stations, APs, and the like.

The communication links 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include at least one carrier, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined. Similarly, communication links 135, also shown in wireless communications system 100, may include UL transmissions from a UE 115 to an AP 110, and/or DL transmissions from an AP 110 to a UE 115.

In some embodiments of the system 100, base stations 105, APs 110, and/or UEs 115 may include multiple antennas for employing antenna diversity schemes to improve communication quality and reliability between base stations 105, APs 110, and UEs 115. Additionally or alternatively, base stations 105, APs 110, and/or UEs 115 may employ multiple-input, multiple-output (MIMO) techniques that may take advantage of multi-path environments to transmit multiple spatial layers carrying the same or different coded data. The APs 110 may be integrated into base stations 105, allowing the base stations 105 to also perform the functions of an AP 110.

System 100 includes a UE 115-a which is in communication with both a base station 105 and an AP 110. As an example, UE 115-a may communicate with the AP 110 using Wi-Fi or other WLAN communications, while the UE 115-a may communicate with the base stations 105 using LTE or other WWAN communications. While the UE 115-a is communicating with one base station 105, the UE 115-a may receive search measurements from neighboring base stations 105. The search measurements may inform the UE 115-a of the frequencies and RATs used by the neighboring base stations 105. The UE 115-a may receive and process the search measurements at or near the same time as other WWAN communications by utilizing a portion of a WLAN transceiver in the UE 115-a. Alternatively, the UE 115-a may be a multi-SIM device and may also utilize a portion of a WLAN transceiver in combination with a WWAN transceiver to support the use of additional SIMs.

Therefore, UE 115-a may include one or more WWAN transceivers and one or more WLAN transceivers. In some circumstances, as in an inter-RAT search or during multi-SIM operations, UE 115-a may use a combined signal path that uses at least a portion of a WWAN transceiver in combination with at least a portion of a WLAN transceiver.

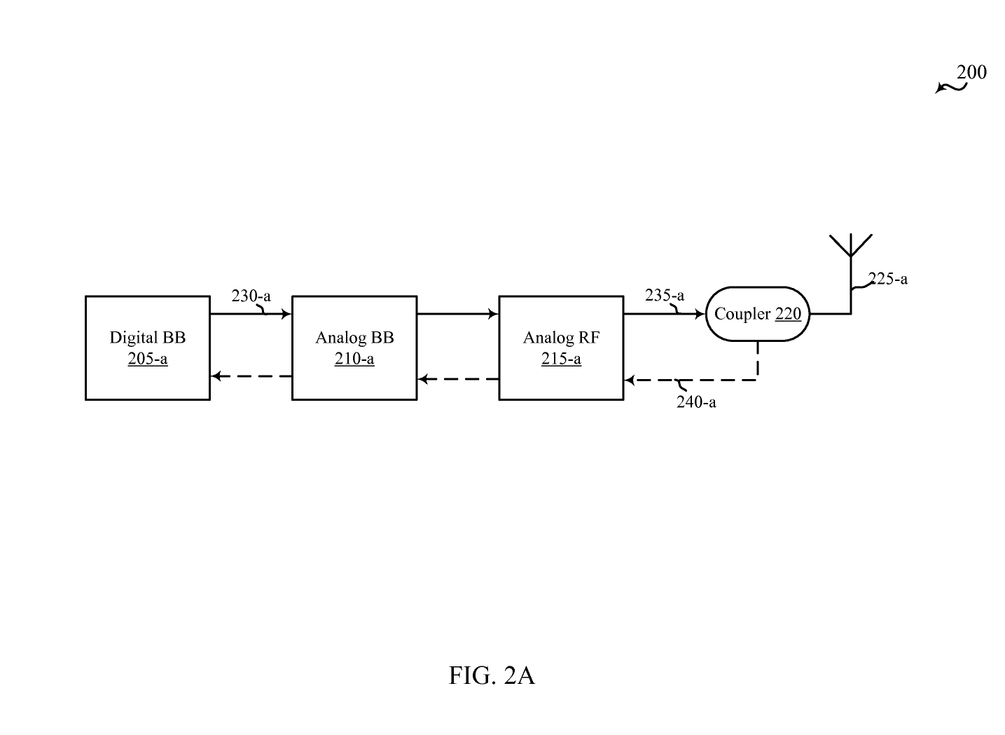

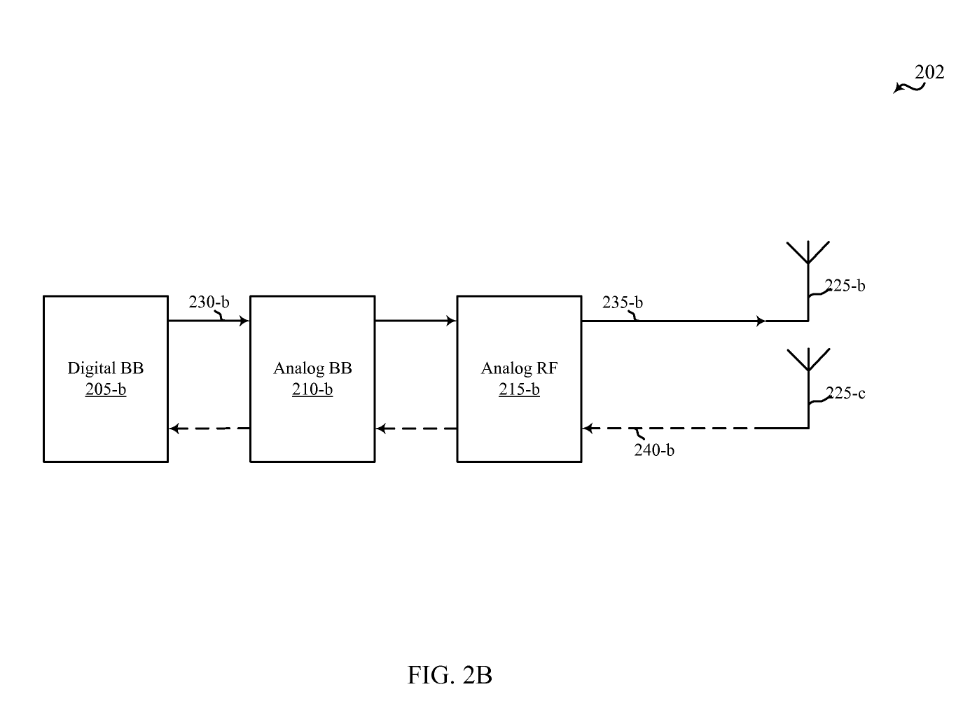

Typically, WWAN and WLAN transceivers have systems and methods for calibrating their respective Tx and Rx signal paths. FIG. 2A shows an example calibration system 200 in a transceiver. In particular, calibration system 200 illustrates a system for calibrating a Tx signal path 230-a by using a feedback Rx path 240-a.

The calibration system 200 includes a digital baseband (BB) chain 205-a, an analog BB chain 210-a, and an analog radio frequency (RF) chain 215-a. Signals to be transmitted along the Tx signal path 230-a are first processed at the digital BB chain 205-a, and then at the analog BB chain 210-a and the analog RF chain 215-a, which may each be part of a transceiver. The signals are then output via the signal output 235-a, and may be transmitted via the antenna 225-a. However, in order to facilitate calibration of the Tx signal path 230-a, a coupler 220 may be included at the intersection of the signal output 235-a and the antenna 225-a. The coupler 220 may be used to couple the Tx signal path 230-a to the feedback Rx path 240-a. The feedback Rx path 240-a proceeds through the same transceiver portions used by the Tx signal path 230-a. Thus, a signal routed through the Tx signal path 230-a and then fed back through the feedback Rx path 240-a may be compared with the original signal in order to determine the amount of calibration that should be applied to signals using the Tx signal path 230-a. The comparison and calibration may thus occur at the digital BB chain 205-a.

FIG. 2B shows another example calibration system 202 in a transceiver. Calibration system 202 illustrates a system for calibrating a Tx signal path 230-b by using a feedback Rx path 240-b.

The calibration system 202 of FIG. 2B is similar to the calibration system 200 of FIG. 2A. The calibration system 202 includes a digital BB chain 205-b, an analog BB chain 210-b, and an analog RF chain 215-b. Signals to be transmitted along the Tx signal path 230-b are first processed at the digital BB chain 205-b, and then at the analog BB chain 210-b and the analog RF chain 215-b, which may each be part of a transceiver. The signals are then output via the signal output 235-b, and may be transmitted via the antenna 225-b. Instead of using a coupler, however, to couple the Tx signal path 230-b to the feedback Rx path 240-b, the signals are allowed to be transmitted via the antenna 235-b and then returned to antenna 235-c and the feedback Rx path 240-b. The feedback Rx path 240-b proceeds through the same transceiver portions used by the Tx signal path 230-b. Thus, FIG. 2B illustrates a method of routing a signal to a feedback path that uses antenna paths instead of couplers. Other methods of routing signals to feedback paths may include switches or cables, for example.

The calibration systems 200, 202 may be included in a WWAN transceiver or in a WLAN transceiver. In these transceivers, a typical signal path may be mirrored by a feedback path that uses the same components, modules or processing of the signal path, thus allowing for effective calibration of the signal path. However, when the signal paths use portions of multiple transceivers, challenges may arise in providing effective calibration of the combined signal paths.

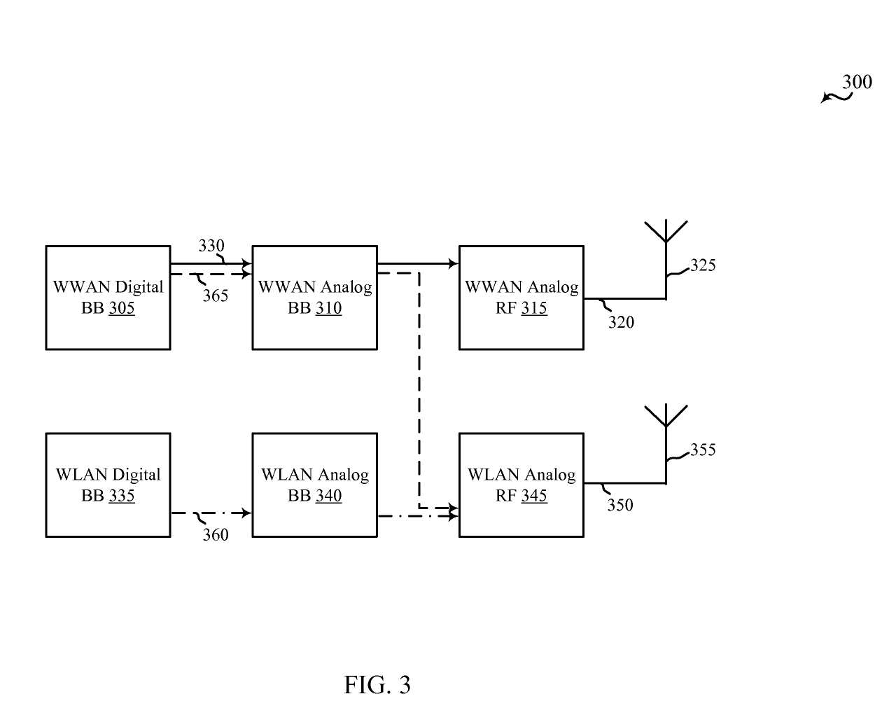

FIG. 3 shows an example of a combined signal path using WWAN and WLAN transceivers. System 300 illustrates a specific example of a combined signal path 365 that uses portions of a WWAN transceiver and portions of a WLAN transceiver. The WWAN transceiver may include a WWAN digital BB chain 305, a WWAN analog BB chain 310, and a WWAN analog RF chain 315. A typical WWAN signal path 330 is illustrated as passing through the WWAN digital BB chain 305, the WWAN analog BB chain 310, and the WWAN analog RF chain 315. The typical WWAN signal path 330 includes input/output 320 and antenna 325, which may be a WWAN antenna.

The WLAN transceiver may include a WLAN digital BB chain 335, a WLAN analog BB chain 340, and a WLAN analog RF chain 345. A typical WLAN signal path 360 is illustrated as passing through the WLAN digital BB chain 335, the WLAN analog BB chain 340, and the WLAN analog RF chain 345. The typical WLAN signal path 360 includes input/output 350 and antenna 355, which may be a WLAN antenna.

The combined signal path 365 is illustrated as flowing through the WWAN digital BB chain 305 and the WWAN analog BB chain 310 of the WWAN transceiver. However, instead of using the WWAN analog RF chain 315, the combined signal path 365 uses the WLAN analog RF chain 345. In the example of FIG. 3, the combined signal path 365 would also use input/output 350 and antenna 355.

The combined signal path 365 illustrated in system 300 is merely one example of a combined signal path that uses portions of both a WWAN transceiver and a WLAN transceiver. Other examples may also exist.

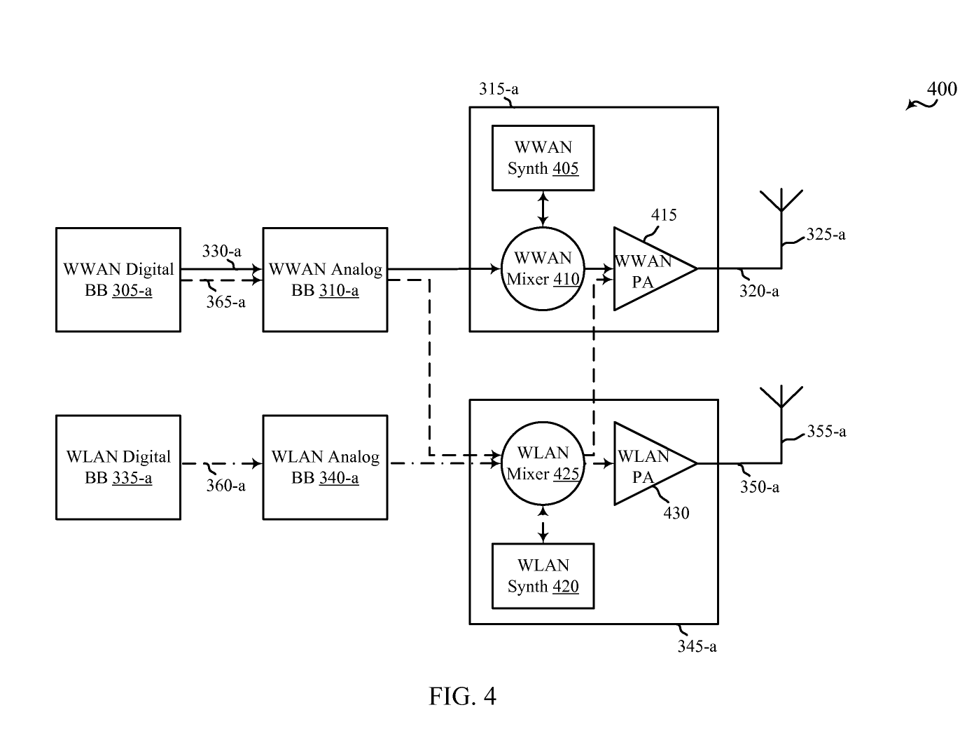

FIG. 4 shows an additional example of a combined signal path using WWAN and WLAN transceivers. System 400 illustrates a specific example of a combined signal path 365-a that uses portions of a WWAN transceiver and portions of a WLAN transceiver. As in system 300 of FIG. 3, the WWAN transceiver may include a WWAN digital BB chain 305-a, a WWAN analog BB chain 310-a, and a WWAN analog RF chain 315-a. The WWAN analog RF chain 315-a may further include a WWAN synthesizer 405, a WWAN mixer 410, and a WWAN power amplifier (PA) 415. A typical WWAN signal path 330-a is illustrated as passing through the WWAN digital BB chain 305-a, the WWAN analog BB chain 310-a, and the WWAN analog RF chain 315-a. In the WWAN analog RF chain 315-a, the WWAN signal path 330-a is processed using the WWAN synthesizer 405, the WWAN mixer 410, and the WWAN PA 415. The WWAN signal path 330-a includes input/output 320-a and antenna 325-a, which may be a WWAN antenna.

The WLAN transceiver may include a WLAN digital BB chain 335-a, a WLAN analog BB chain 340-a, and a WLAN analog RF chain 345-a. The WLAN analog RF chain 345-a may further include a WLAN synthesizer 420, a WLAN mixer 425, and a WLAN PA 430. A typical WLAN signal path 360-a is illustrated as passing through the WLAN digital BB chain 335-a, the WLAN analog BB chain 340-a, and the WLAN analog RF chain 345-a. In the WLAN analog RF chain 345-a, the WLAN signal path 360-a is processed using the WLAN synthesizer 420, the WLAN mixer 425, and the WLAN PA 430. The typical WLAN signal path 360-a includes input/output 350-a and antenna 355-a, which may be a WLAN antenna.

The combined signal path 365-a is illustrated as flowing through the WWAN digital BB chain 305-a and the WWAN analog BB chain 310-a of the WWAN transceiver. The combined signal path 365-a also uses portions of both the WWAN analog RF chain 315-a and the WLAN analog RF chain 345-a. Specifically, in the example of FIG. 4, the combined signal path 365-a uses the WLAN mixer 425 and the WLAN synthesizer 420 of the WLAN analog RF chain 345-a and the WWAN PA 415 of the WWAN analog RF chain 315-a. In the example of FIG. 4, the combined signal path 365-a would also use input/output 320-a and antenna 325-a.

The combined signal paths 365 illustrated in systems 300, 400 of FIGS. 3 and 4 demonstrate examples of how a WWAN and a WLAN transceiver in a UE (such as UE 115 of FIG. 1) may be used by a single signal path. However, just as WLAN signal paths 330 and WWAN signal paths 360 may be calibrated (for example, as described with relation to calibration system 200 of FIG. 2), the combined signal paths 365 may also be calibrated. As described below, various feedback paths may be used to calibrate the combined signal paths 365. While particular examples of combined signal paths may be provided in the description below, the examples may be generalized to reflect the use of WWAN and WLAN feedback paths to calibrate any type of combined signal path that uses portions of both a WWAN transceiver and a WLAN transceiver.

Signal path calibration may be used to calibrate both combined Tx signal paths and combined Rx signal paths. Calibration of combined Tx signal paths may be used to correct for noise and other signal irregularities resulting from, for example, power or gain inaccuracies, local oscillator (LO) feedthrough, or in-phase and quadrature phase (IQ) imbalance (as indicated through residual side band (RSB)). Direct current (DC) offset may also negatively affect a signal and be corrected through calibration. In addition, digital pre-distortion and the operations of Tx BB filters, Tx self-tests (e.g., adjacent channel leakage-power ratio (ACLR) tests and error vector magnitude (EVM) tests), and PA power calibration may all result in signal irregularities that may be corrected through calibration. Calibration of combined Rx signal paths may be used to correct for noise and signal irregularities arising from both DC offset and receiver second order intercept point (IP2), for example.

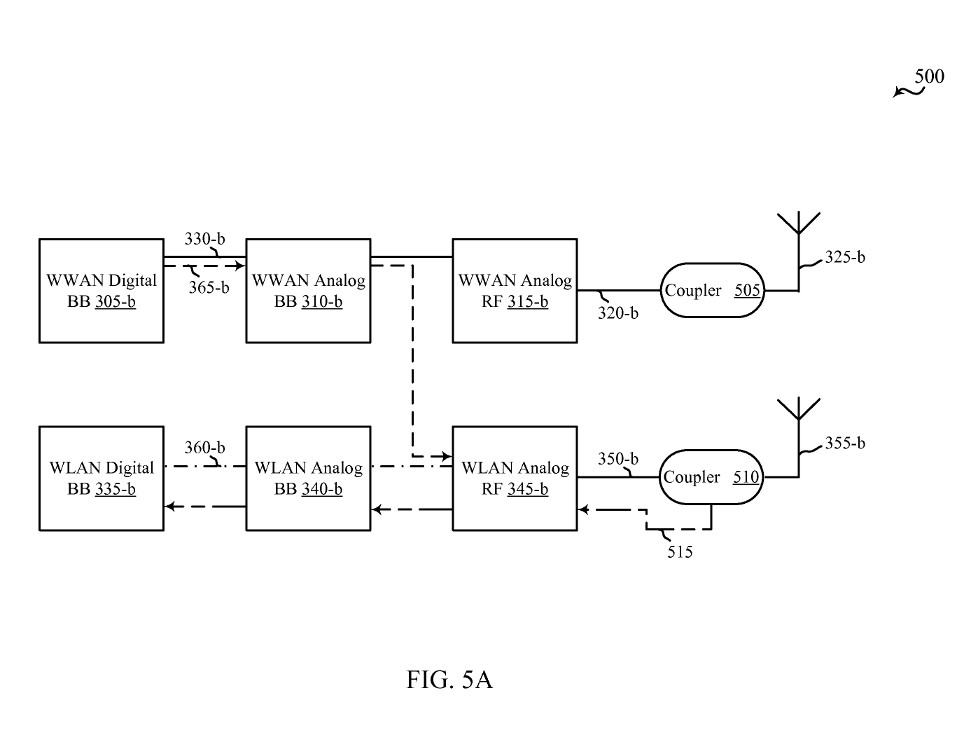

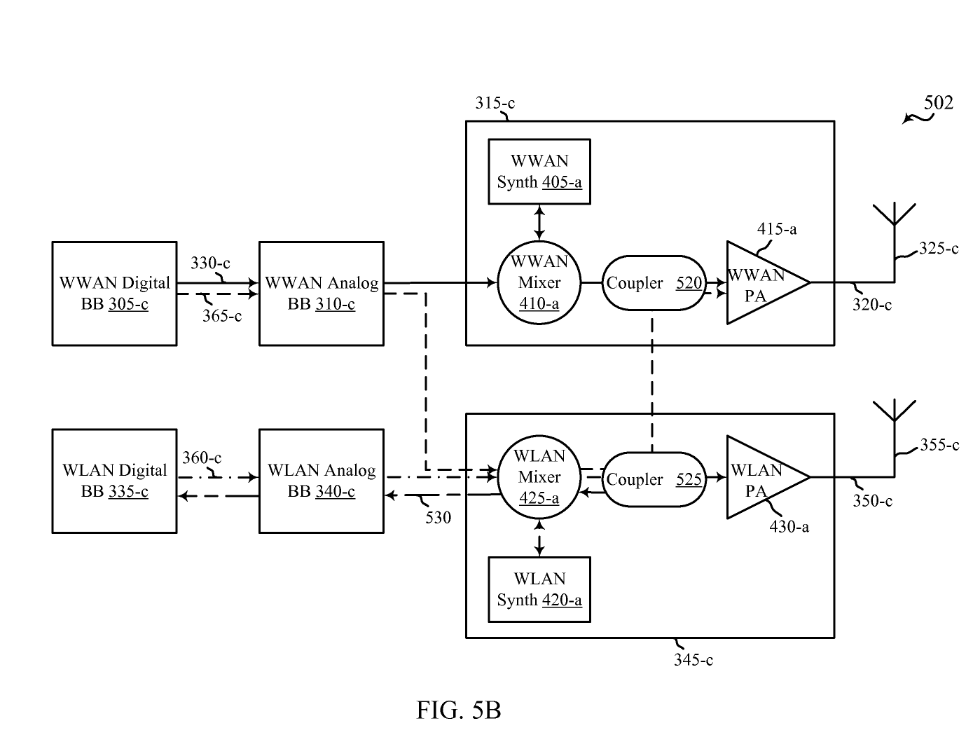

FIG. 5A shows an example calibration system 500 for a combined signal path that uses both WWAN and WLAN transceivers. The example calibration system 500 illustrates one possible calibration option for a combined signal path as described in system 300 of FIG. 3. Additionally, the calibration system 500 may also be used in connection with other combined signal paths.

Calibration system 500 illustrates a system for calibrating combined signal path 365-b that uses portions of a WWAN transceiver and portions of a WLAN transceiver. The WWAN transceiver may include a WWAN digital BB chain 305-b, a WWAN analog BB chain 310-b, and a WWAN analog RF chain 315-b. A typical WWAN signal path 330-b is illustrated as passing through the WWAN digital BB chain 305-b, the WWAN analog BB chain 310-b, and the WWAN analog RF chain 315-b. The typical WWAN signal path 330-b includes input/output 320-b and antenna 325-b, which may be a WWAN antenna.

The WLAN transceiver may include a WLAN digital BB chain 335-b, a WLAN analog BB chain 340-b, and a WLAN analog RF chain 345-b. A typical WLAN signal path 360-b is illustrated as passing through the WLAN digital BB chain 335-b, the WLAN analog BB chain 340-b, and the WLAN analog RF chain 345-b. The typical WLAN signal path 360-b includes input/output 350-b and antenna 355-b, which may be a WLAN antenna.

The combined signal path 365-b is illustrated as flowing through the WWAN digital BB chain 305-b and the WWAN analog BB chain 310-b of the WWAN transceiver. However, instead of using the WWAN analog RF chain 315-b, the combined signal path 365-b uses the WLAN analog RF chain 345-b. In the example of FIG. 5A, the combined signal path 365-b would also use input/output 350-b and antenna 355-b.

The calibration system 500 also includes couplers 505, 510. Coupler 505 is included between the input/output 320-b and the antenna 325-b, while coupler 510 is included between the input/output 350-b and the antenna 355-b. The couplers 505, 510 may be used to couple a signal path to a feedback path. For example, coupler 510 may be used to couple the combined signal path 365-b to WLAN feedback path 515. Thus, in this example, the combined signal path 365-b is calibrated using the WLAN feedback path 515, which travels through the WLAN analog RF chain 345-b, the WLAN analog BB chain 340-b, and the WLAN digital BB chain 335-b. Calibration processing may be performed at the WLAN digital BB chain 335-b, for example. In order to use the WLAN feedback path 515 to calibrate WWAN signals, the WLAN feedback path 515 may need to be modified to support WWAN analog signals, for example.

While the WLAN feedback path 515 may be used to calibrate the combined signal path 365-b, this solution may introduce some calibration errors. In particular, the combined signal path 365-b uses the WWAN digital BB chain 305-b, the WWAN analog BB chain 310-b, and the WLAN analog RF chain 345-b, while the WLAN feedback path 515 uses the WLAN digital BB chain 335-b, the WLAN analog BB chain 340-b, and the WLAN analog RF chain 345-b. Thus, differences between the WWAN digital BB chain 305-b and the WLAN digital BB chain 335-b, as well as between the WWAN analog BB chain 310-b and the WLAN analog BB chain 340-b may result in signal mismatch, and thus calibration errors. Accordingly, the calibration system 500 may be limited in its application.

While calibration system 500 has been illustrated with respect to a specific combined signal path 365-b, calibration system 500 may also be used in connection with other combined signal paths by simply using the WLAN feedback path 515 in calibrating the combined signal path. Calibration system 500 may also be generalized to the use of an existing feedback path that uses a same analog RF chain as that from which the combined signal path is output. Additionally, while calibration system 500 has been illustrated with couplers 505, 510, other methods of coupling the combined signal path 365-b with the WLAN feedback path 515 may be used. For example, coupling between the combined signal path 365-b and the WLAN feedback path 515 may be accomplished using an antenna path, a cable, a switch, a coupler, or via combinations of the same.

FIG. 5B shows an example calibration system 502 for a combined signal path that uses both WWAN and WLAN transceivers. The example calibration system 502 illustrates one possible calibration option for a combined signal path as described in system 400 of FIG. 4. Additionally, the calibration system 502 may also be used in connection with other combined signal paths.

Calibration system 502 illustrates a system for calibrating combined signal path 365-c that uses portions of a WWAN transceiver and portions of a WLAN transceiver. The WWAN transceiver may include a WWAN digital BB chain 305-c, a WWAN analog BB chain 310-c, and a WWAN analog RF chain 315-c. The WWAN analog RF chain 315-c may further include a WWAN synthesizer 405-a, a WWAN mixer 410-a, and a WWAN PA 415-a. A typical WWAN signal path 330-c is illustrated as passing through the WWAN digital BB chain 305-c, the WWAN analog BB chain 310-c, and the WWAN analog RF chain 315-c. In the WWAN analog RF chain 315-c, the WWAN signal path 330-c is processed using the WWAN synthesizer 405-a, the WWAN mixer 410-a, and the WWAN PA 415-a. The WWAN signal path 330-c includes input/output 320-c and antenna 325-c, which may be a WWAN antenna.

The WLAN transceiver may include a WLAN digital BB chain 335-c, a WLAN analog BB chain 340-c, and a WLAN analog RF chain 345-c. The WLAN analog RF chain 345-c may further include a WLAN synthesizer 420-a, a WLAN mixer 425-a, and a WLAN PA 430-a. A typical WLAN signal path 360-c is illustrated as passing through the WLAN digital BB chain 335-c, the WLAN analog BB chain 340-c, and the WLAN analog RF chain 345-c. In the WLAN analog RF chain 345-c, the WLAN signal path 360-c is processed using the WLAN synthesizer 420-a, the WLAN mixer 425-a, and the WLAN PA 430-a. The typical WLAN signal path 360-c includes input/output 350-c and antenna 355-c, which may be a WLAN antenna.

The combined signal path 365-c is illustrated as flowing through the WWAN digital BB chain 305-c and the WWAN analog BB chain 310-c of the WWAN transceiver. However, instead of using the entirety of the WWAN analog RF chain 315-c, the combined signal path 365-c uses a portion of the WLAN analog RF chain 345-c. Specifically, in the example of FIG. 5B, the combined signal path 365-c uses the WLAN mixer 425-a and the WLAN synthesizer 420-a of the WLAN analog RF chain 345-c and the WWAN PA 415-a of the WWAN analog RF chain 315-c. In the example of FIG. 5B, the combined signal path 365-c would also use input/output 320-c and antenna 325-c.

The calibration system 502 also includes couplers 520, 525. Coupler 520 is included between the WWAN mixer 410-a and the WWAN PA 415-a, while coupler 525 is included between the WLAN mixer 425-a and the WLAN PA 430-a. The couplers 520, 525 may be used to couple a signal path to a feedback path. For example, coupler 525 may be used to couple the combined signal path 365-c to WLAN feedback path 530. Thus, in this example, the combined signal path 365-c is calibrated using the WLAN feedback path 530, which travels through the WLAN mixer 425-a, the WLAN synthesizer 420-a, the WLAN analog BB chain 340-c, and the WLAN digital BB chain 335-c. Calibration processing may be performed at the WLAN digital BB chain 335-c, for example.

The WLAN feedback path 530 is also an example of a feedback path that provides calibration for only some (and not all) of the elements of the WLAN transceiver. In the example of calibration system 502, the WLAN feedback path 530 does not provide calibration of errors arising from some elements of the WLAN analog RF chain 345-c (for example, the WLAN PA 430-a).

Thus, like the WLAN feedback path 515 of FIG. 5A, the WLAN feedback path 530 may introduce some calibration errors. In particular, the combined signal path 365-c uses the WWAN digital BB chain 305-c, the WWAN analog BB chain 310-c, and portions of both the WLAN analog RF chain 345-c and the WWAN analog RF chain 315-c, while the WLAN feedback path 530 uses the WLAN digital BB chain 335-c, the WLAN analog BB chain 340-c, and a portion of the WLAN analog RF chain 345-c. Thus, differences between the WWAN digital BB chain 305-c and the WLAN digital BB chain 335-c, as well as between the WWAN analog BB chain 310-c and the WLAN analog BB chain 340-c may result in signal mismatch, and thus calibration errors. Additionally, the WLAN feedback path 530 would not provide calibration for errors that may arise from the portions of the WWAN analog RF chain 315-c through which the combined signal path 365-c travels. Accordingly, the calibration system 502 may be limited in its application.

While calibration system 502 has been illustrated with respect to a specific combined signal path 365-c, calibration system 502 may also be used in connection with other combined signal paths by simply using the WLAN feedback path 530 in calibrating the combined signal path. Calibration system 502 may also be generalized to the use of an existing feedback path that uses a different analog RF chain as that from which the combined signal path is output. Additionally, while calibration system 502 has been illustrated with couplers 520, 525, other methods of coupling the combined signal path 365-c with the WLAN feedback path 530 may be used. For example, coupling between the combined signal path 365-c and the WLAN feedback path 530 may be accomplished using an antenna path, a cable, a switch, a coupler, or via combinations of the same.

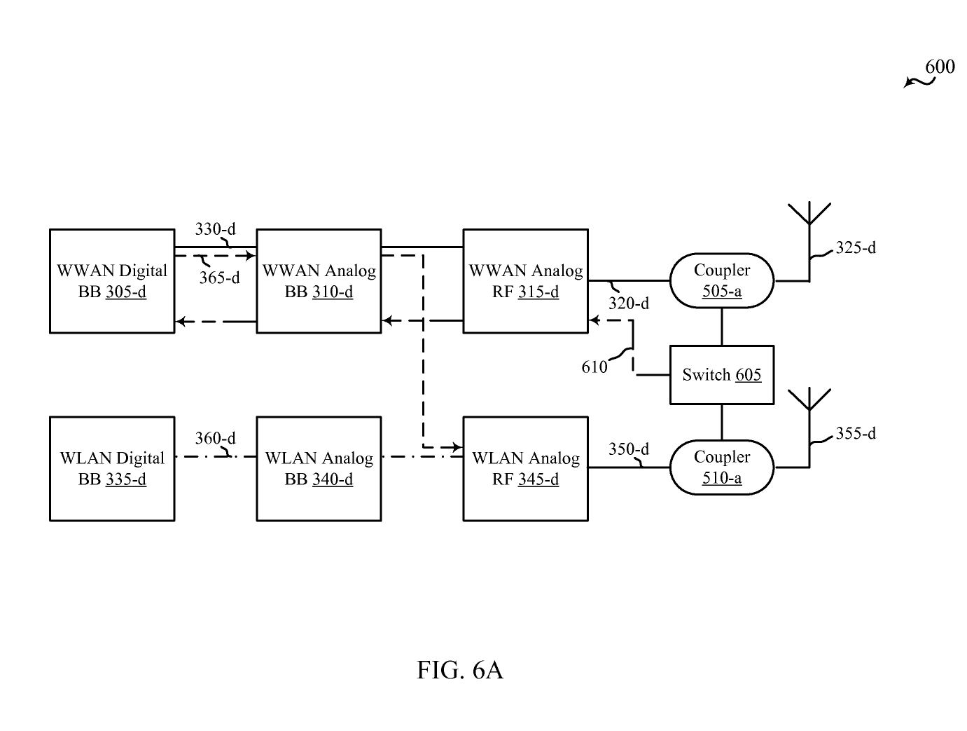

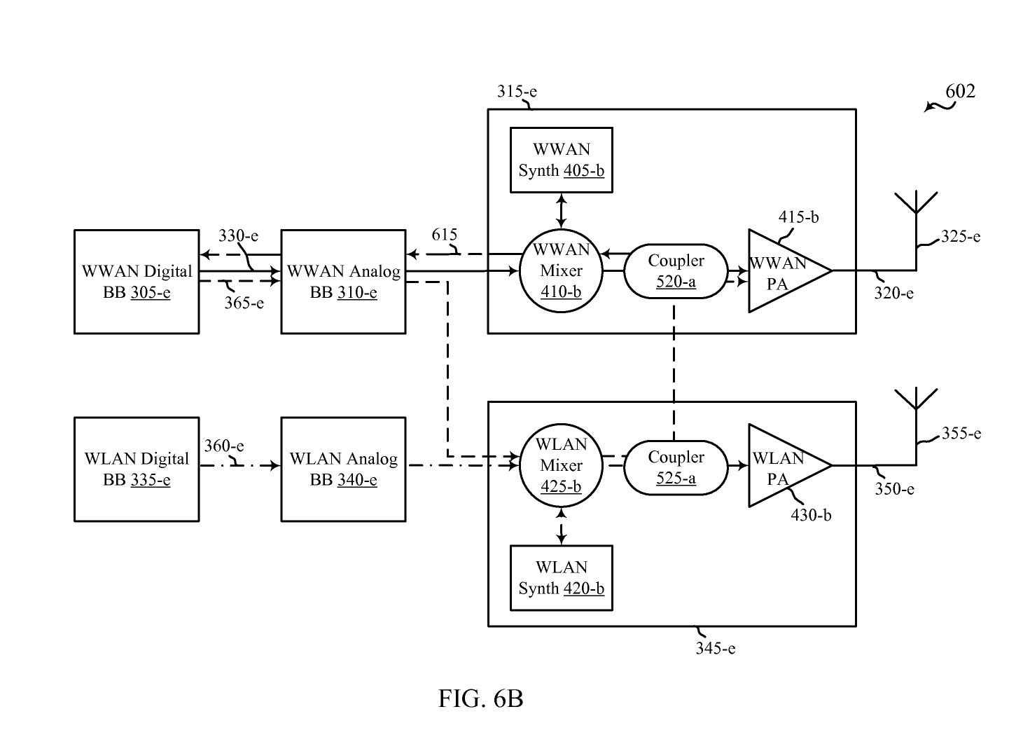

FIG. 6A shows another example calibration system 600 for a combined signal path that uses both WWAN and WLAN transceivers. The example calibration system 600 illustrates one possible calibration option for a combined signal path as described in system 300 of FIG. 3. Additionally, the calibration system 600 may also be used in connection with other combined signal paths.

Calibration system 600 illustrates a system for calibrating combined signal path 365-d that uses portions of a WWAN transceiver and portions of a WLAN transceiver. The WWAN transceiver may include a WWAN digital BB chain 305-d, a WWAN analog BB chain 310-d, and a WWAN analog RF chain 315-d. A typical WWAN signal path 330-d is illustrated as passing through the WWAN digital BB chain 305-d, the WWAN analog BB chain 310-d, and the WWAN analog RF chain 315-d. The typical WWAN signal path 330-d includes input/output 320-d and antenna 325-d, which may be a WWAN antenna.

The WLAN transceiver may include a WLAN digital BB chain 335-d, a WLAN analog BB chain 340-d, and a WLAN analog RF chain 345-d. A typical WLAN signal path 360-d is illustrated as passing through the WLAN digital BB chain 335-d, the WLAN analog BB chain 340-d, and the WLAN analog RF chain 345-d. The typical WLAN signal path 360-d includes input/output 350-d and antenna 355-d, which may be a WLAN antenna.

The combined signal path 365-d is illustrated as flowing through the WWAN digital BB chain 305-d and the WWAN analog BB chain 310-d of the WWAN transceiver. However, instead of using the WWAN analog RF chain 315-d, the combined signal path 365-d uses the WLAN analog RF chain 345-d. In the example of FIG. 6A, the combined signal path 365-d would also use input/output 350-d and antenna 355-d.

The calibration system 600 also includes couplers 505-a, 510-a, as well as switch 605. Coupler 505-a is included between the input/output 320-d and the antenna 325-d, while coupler 510-a is included between the input/output 350-d and the antenna 355-d. The couplers 505-a, 510-a may be used to couple a signal path to a feedback path. Switch 605 allows for the couplers 505-a, 510-a to couple signal paths to a feedback path using a different analog RF chain. Thus, and for example, coupler 510-a may be used to couple the combined signal path 365-d to WWAN feedback path 610 via switch 605. Thus, in this example, the combined signal path 365-d is calibrated using the WWAN feedback path 610, which travels through the WWAN analog RF chain 315-d, the WWAN analog BB chain 310-d, and the WWAN digital BB chain 305-d. Calibration processing may be performed at the WWAN digital BB chain 305-d, for example. Unlike the calibration system 500, the WWAN feedback path 610 does not require any modification to support WWAN analog signals.

However, as with the calibration system 500 of FIG. 5A, the use of the WWAN feedback path 610 to calibrate the combined signal path 365-d may introduce some calibration errors. In particular, the combined signal path 365-d uses the WWAN digital BB chain 305-d, the WWAN analog BB chain 310-d, and the WLAN analog RF chain 345-d, while the WWAN feedback path 610 uses the WWAN digital BB chain 315-d, the WWAN analog BB chain 310-d, and the WWAN analog RF chain 305-d. Thus, differences between the WWAN analog RF chain 315-d and the WLAN analog RF chain 345-d may result in signal mismatch, and thus calibration errors. Accordingly, the calibration system 600 may be limited in its application.

While calibration system 600 has been illustrated with respect to a specific combined signal path 365-d, calibration system 600 may also be used in connection with other combined signal paths by simply using the WWAN feedback path 610 in calibrating the combined signal path. Calibration system 600 may also be generalized to the use of an existing feedback path that uses a different analog RF chain as that from which the combined signal path is output. Additionally, while calibration system 600 has been illustrated with couplers 505-a, 510-a and switch 605, other methods of coupling the combined signal path 365-d with the WWAN feedback path 610 may be used. For example, coupling between the combined signal path 365-d and the WWAN feedback path 610 may be accomplished using an antenna path, a cable, a switch, a coupler, or via combinations of the same.

FIG. 6B shows another example calibration system 602 for a combined signal path that uses both WWAN and WLAN transceivers. The example calibration system 602 illustrates one possible calibration option for a combined signal path as described in system 400 of FIG. 4. Additionally, the calibration system 602 may also be used in connection with other combined signal paths.

Calibration system 602 illustrates a system for calibrating combined signal path 365-e that uses portions of a WWAN transceiver and portions of a WLAN transceiver. The WWAN transceiver may include a WWAN digital BB chain 305-e, a WWAN analog BB chain 310-e, and a WWAN analog RF chain 315-e. The WWAN analog RF chain 315-e may further include a WWAN synthesizer 405-b, a WWAN mixer 410-b, and a WWAN PA 415-b. A typical WWAN signal path 330-e is illustrated as passing through the WWAN digital BB chain 305-e, the WWAN analog BB chain 310-e, and the WWAN analog RF chain 315-e. In the WWAN analog RF chain 315-e, the WWAN signal path 330-e is processed using the WWAN synthesizer 405-b, the WWAN mixer 410-b, and the WWAN PA 415-b. The WWAN signal path 330-e includes input/output 320-e and antenna 325-e, which may be a WWAN antenna.

The WLAN transceiver may include a WLAN digital BB chain 335-e, a WLAN analog BB chain 340-e, and a WLAN analog RF chain 345-e. The WLAN analog RF chain 345-e may further include a WLAN synthesizer 420-b, a WLAN mixer 425-b, and a WLAN PA 430-b. A typical WLAN signal path 360-e is illustrated as passing through the WLAN digital BB chain 335-e, the WLAN analog BB chain 340-e, and the WLAN analog RF chain 345-e. In the WLAN analog RF chain 345-e, the WLAN signal path 360-e is processed using the WLAN synthesizer 420-b, the WLAN mixer 425-b, and the WLAN PA 430-b. The typical WLAN signal path 360-e includes input/output 350-e and antenna 355-e, which may be a WLAN antenna.

The combined signal path 365-e is illustrated as flowing through the WWAN digital BB chain 305-e and the WWAN analog BB chain 310-e of the WWAN transceiver. However, instead of using the entirety of the WWAN analog RF chain 315-e, the combined signal path 365-e uses a portion of the WLAN analog RF chain 345-e. Specifically, in the example of FIG. 6B, the combined signal path 365-e uses the WLAN mixer 425-b and the WLAN synthesizer 420-b of the WLAN analog RF chain 345-e and the WWAN PA 415-b of the WWAN analog RF chain 315-e. In the example of FIG. 6B, the combined signal path 365-e would also use input/output 320-e and antenna 325-e.

The calibration system 602 also includes couplers 520-a, 525-a. Coupler 520-a is included between the WWAN mixer 410-b and the WWAN PA 415-b, while coupler 525-a is included between the WLAN mixer 425-b and the WLAN PA 430-b. The couplers 520-a, 525-a may be used to couple a signal path to a feedback path. For example, coupler 525-a may be used to couple the combined signal path 365-e to WWAN feedback path 615. Thus, in this example, the combined signal path 365-e is calibrated using the WWAN feedback path 615, which travels through the WWAN mixer 410-b, the WWAN synthesizer 405-b, the WWAN analog BB chain 310-e, and the WWAN digital BB chain 305-e. Calibration processing may be performed at the WWAN digital BB chain 305-e, for example.

The WWAN feedback path 615 is also an example of a feedback path that provides calibration for only some (and not all) of the elements of the WWAN transceiver. In the example of calibration system 602, the WWAN feedback path 615 does not provide calibration of errors arising from some elements of the WWAN analog RF chain 315-e (for example, the WWAN PA 415-b).

Thus, like the WWAN feedback path 610 of FIG. 6A, the WWAN feedback path 615 may introduce some calibration errors. In particular, the combined signal path 365-e uses the WWAN digital BB chain 305-e, the WWAN analog BB chain 310-e, and portions of both the WLAN analog RF chain 345-e and the WWAN analog RF chain 315-e, while the WWAN feedback path 615 uses the WWAN digital BB chain 305-e, the WWAN analog BB chain 310-e, and a portion of the WWAN analog RF chain 315-e. Thus, differences between the WWAN mixer 410-b and the WLAN mixer 425-b, as well as between the WWAN synthesizer 405-b and the WLAN synthesizer 420-b may result in signal mismatch, and thus calibration errors. Additionally, the WWAN feedback path 615 would not provide calibration for errors that may arise from the WWAN PA 415-b, through which the combined signal path 365-e travels. Accordingly, the calibration system 602 may be limited in its application.

While calibration system 602 has been illustrated with respect to a specific combined signal path 365-e, calibration system 602 may also be used in connection with other combined signal paths by simply using the WWAN feedback path 615 in calibrating the combined signal path. Calibration system 602 may also be generalized to the use of an existing feedback path that uses a same analog RF chain as that from which the combined signal path is output. Additionally, while calibration system 602 has been illustrated with couplers 520-a, 525-a, other methods of coupling the combined signal path 365-e with the WWAN feedback path 615 may be used. For example, coupling between the combined signal path 365-e and the WWAN feedback path 615 may be accomplished using an antenna path, a cable, a switch, a coupler, or via combinations of the same.

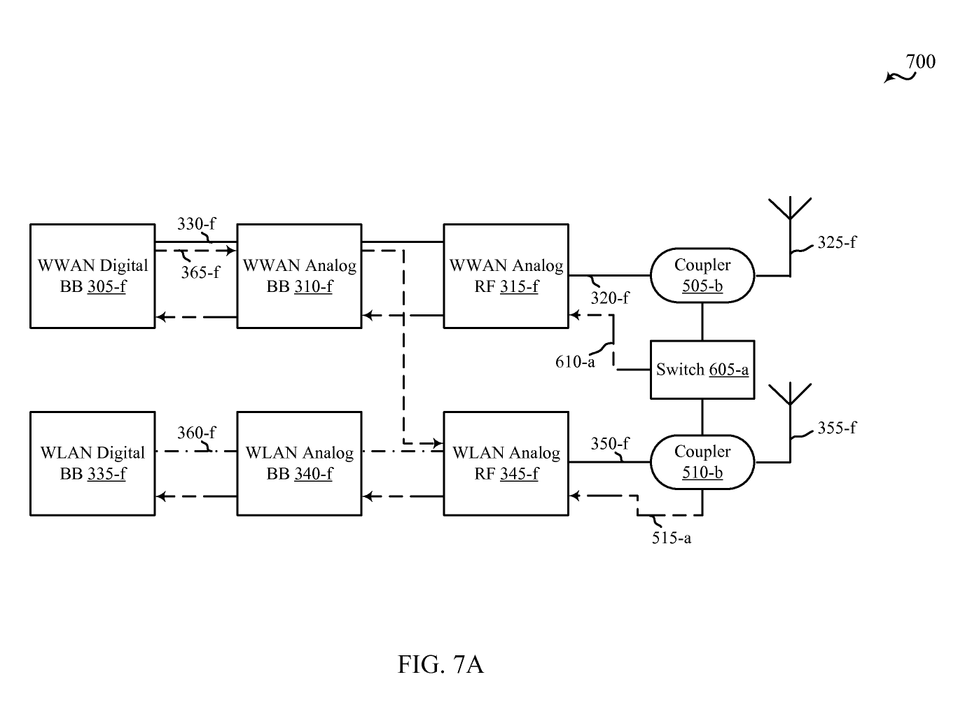

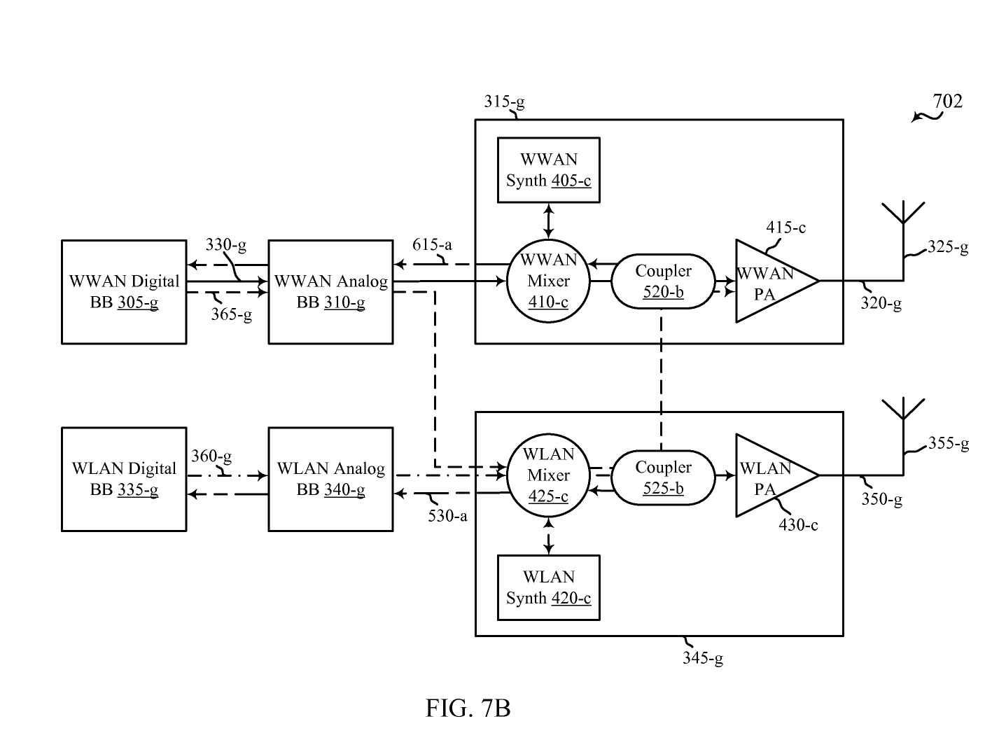

FIG. 7A shows a different example calibration system 700 for a combined signal path that uses both WWAN and WLAN transceivers. The example calibration system 700 illustrates one possible calibration option for a combined signal path as described in system 300 of FIG. 3. Additionally, the calibration system 700 may also be used in connection with other combined signal paths.

Calibration system 700 illustrates a system for calibrating combined signal path 365-f that uses portions of a WWAN transceiver and portions of a WLAN transceiver. The WWAN transceiver may include a WWAN digital BB chain 305-f, a WWAN analog BB chain 310-f, and a WWAN analog RF chain 315-f. A typical WWAN signal path 330-f is illustrated as passing through the WWAN digital BB chain 305-f, the WWAN analog BB chain 310-f, and the WWAN analog RF chain 315-f. The typical WWAN signal path 330-f includes input/output 320-f and antenna 325-f, which may be a WWAN antenna.

The WLAN transceiver may include a WLAN digital BB chain 335-f, a WLAN analog BB chain 340-f, and a WLAN analog RF chain 345-f. A typical WLAN signal path 360-f is illustrated as passing through the WLAN digital BB chain 335-f, the WLAN analog BB chain 340-f, and the WLAN analog RF chain 345-f. The typical WLAN signal path 360-f includes input/output 350-f and antenna 355-f, which may be a WLAN antenna.

The combined signal path 365-f is illustrated as flowing through the WWAN digital BB chain 305-f and the WWAN analog BB chain 310-f of the WWAN transceiver. Instead of using the WWAN analog RF chain 315-f, the combined signal path 365-f uses the WLAN analog RF chain 345-f. In the example of FIG. 7A, the combined signal path 365-f would also use input/output 350-f and antenna 355-f.

Like the calibration system 600 (of FIG. 6A), the calibration system 700 also includes couplers 505-b, 510-b, and switch 605-a. Coupler 505-b is included between the input/output 320-f and the antenna 325-f, while coupler 510-b is included between the input/output 350-f and the antenna 355-f. The couplers 505-b, 510-b may be used to couple a signal path to a feedback path, either directly or via switch 605-a. Thus, for example, in calibration system 700, combined signal path 365-f is coupled to WLAN feedback path 515-a via coupler 510-b. Additionally, combined signal path 365-f is coupled to WWAN feedback path 610-a via coupler 510-b and switch 605-a. This means that both WLAN feedback path 515-a and WWAN feedback path 610-a are used in calibrating the combined signal path 365-f. Calibration processing may be performed in both the WLAN digital BB chain 335-f and the WWAN digital BB chain 305-f.

Calibration system 700, then, allows for the calibration of combined signal path 365-f using two different feedback paths, thus combining many of the benefits of both calibration systems 500, 600 (of FIGS. 5A and 6A, respectively), while eliminating some of the disadvantages to using either of calibration systems 500, 600. While use of calibration system 500 could arise in calibration errors due to potential mismatch between unshared components of the combined signal path 365-b and the WLAN feedback path 515 (of FIG. 5A), in the calibration system 700, the potential for calibration errors is reduced by simultaneously using the WLAN feedback path 515-a and the WWAN feedback path 610-a. Similarly, while use of calibration system 600 could arise in calibration errors due to potential mismatch between unshared components of the combined signal path 365-d and the WWAN feedback path 610 (of FIG. 6A), in the calibration system 700, the potential for calibration errors is once again reduced by simultaneously using the WLAN feedback path 515-a and the WWAN feedback path 610-a.

For example, in the calibration system 700, combined signal path 365-f uses a greater number of components in the WWAN transceiver than in the WLAN transceiver. Thus, during calibration, the amount of calibration determined by using the WWAN feedback path 610-a may be given a greater weight than the amount of calibration determined by using the WLAN feedback path 515-a. Alternatively, feedback path calibration weighting may be based on not only the number of components used in each transceiver by the combined signal path 365-f, but also by the type of components used in each transceiver by the combined signal path 365-f. For example, if certain components are known to contribute more noise than other components (and thus require more calibration), the feedback path that includes the most noisy components can be accorded greater weight. Therefore, calibration amounts determined at both the WWAN digital BB chain 305-f and the WLAN digital BB chain 335-f may be combined via a weighted summing operation.

Further, the WLAN feedback path 515-a may be calibrated with respect to the WWAN feedback path 610-a. In this way, even though WWAN signals may be propagated along the WLAN feedback path 515-a, the WLAN feedback path 515-a need not be modified for the WWAN signals. Instead, calibration results determined at the WLAN feedback path 515-a may be scaled or weighted with respect to the calibration results determined at the WWAN feedback path 610-a in order to account for WWAN-related differences.

While calibration system 700 has been illustrated with respect to a specific combined signal path 365-f, calibration system 700 may also be used in connection with other combined signal paths by simply using both the WLAN feedback path 515-a and the WWAN feedback path 610-a in calibrating the combined signal path. For example, calibration system 700 may be used in connection with system 400 of FIG. 4. Additionally, while calibration system 700 has been illustrated with couplers 505-b, 510-b and switch 605-a, other methods of coupling the combined signal path 365-f with the WLAN feedback path 515-a and with the WWAN feedback path 610-a may be used. For example, coupling between the combined signal path 365-f and the WLAN feedback path 515-a and WWAN feedback path 610-a may be accomplished using an antenna path, a cable, a switch, a coupler, or via combinations of the same.

FIG. 7B shows yet another example calibration system 702 for a combined signal path that uses both WWAN and WLAN transceivers. The example calibration system 702 illustrates one possible calibration option for a combined signal path as described in system 400 of FIG. 4. Additionally, the calibration system 702 may also be used in connection with other combined signal paths.

Calibration system 702 illustrates a system for calibrating combined signal path 365-g that uses portions of a WWAN transceiver and portions of a WLAN transceiver. The WWAN transceiver may include a WWAN digital BB chain 305-g, a WWAN analog BB chain 310-g, and a WWAN analog RF chain 315-g. The WWAN analog RF chain 315-g may further include a WWAN synthesizer 405-c, a WWAN mixer 410-c, and a WWAN PA 415-c. A typical WWAN signal path 330-g is illustrated as passing through the WWAN digital BB chain 305-g, the WWAN analog BB chain 310-g, and the WWAN analog RF chain 315-g. In the WWAN analog RF chain 315-g, the WWAN signal path 330-g is processed using the WWAN synthesizer 405-c, the WWAN mixer 410-c, and the WWAN PA 415-c. The WWAN signal path 330-g includes input/output 320-g and antenna 325-g, which may be a WWAN antenna.

The WLAN transceiver may include a WLAN digital BB chain 335-g, a WLAN analog BB chain 340-g, and a WLAN analog RF chain 345-g. The WLAN analog RF chain 345-g may further include a WLAN synthesizer 420-c, a WLAN mixer 425-c, and a WLAN PA 430-c. A typical WLAN signal path 360-g is illustrated as passing through the WLAN digital BB chain 335-g, the WLAN analog BB chain 340-g, and the WLAN analog RF chain 345-g. In the WLAN analog RF chain 345-g, the WLAN signal path 360-g is processed using the WLAN synthesizer 420-c, the WLAN mixer 425-c, and the WLAN PA 430-c. The typical WLAN signal path 360-g includes input/output 350-g and antenna 355-g, which may be a WLAN antenna.

The combined signal path 365-g is illustrated as flowing through the WWAN digital BB chain 305-g and the WWAN analog BB chain 310-g of the WWAN transceiver. However, instead of using the entirety of the WWAN analog RF chain 315-g, the combined signal path 365-g uses a portion of the WLAN analog RF chain 345-g. Specifically, in the example of FIG. 7B, the combined signal path 365-g uses the WLAN mixer 425-c and the WLAN synthesizer 420-c of the WLAN analog RF chain 345-g and the WWAN PA 415-c of the WWAN analog RF chain 315-g. In the example of FIG. 7B, the combined signal path 365-g would also use input/output 320-g and antenna 325-g.

The calibration system 702 also includes couplers 520-b, 525-b. Coupler 520-b is included between the WWAN mixer 410-c and the WWAN PA 415-c, while coupler 525-b is included between the WLAN mixer 425-c and the WLAN PA 430-c. The couplers 520-b, 525-b may be used to couple a signal path to a feedback path. Thus, for example, in calibration system 702, combined signal path 365-g is coupled to WLAN feedback path 530-a via coupler 525-b. Additionally, combined signal path 365-g is coupled to WWAN feedback path 615-a via coupler 520-b. This means that both WLAN feedback path 530-b and WWAN feedback path 615-b are used in calibrating the combined signal path 365-g. Calibration processing may be performed in both the WLAN digital BB chain 335-g and the WWAN digital BB chain 305-g.

Calibration system 702, then, allows for the calibration of combined signal path 365-g using two different feedback paths, thus combining many of the benefits of both calibration systems 502, 602 (of FIGS. 5B and 6B, respectively), while eliminating some of the disadvantages to using either of calibration systems 502, 602. While use of calibration system 502 could arise in calibration errors due to potential mismatch between unshared components of the combined signal path 365-c and the WLAN feedback path 530 (of FIG. 5B), in the calibration system 702, the potential for calibration errors is reduced by simultaneously using the WLAN feedback path 530-b and the WWAN feedback path 615-b. Similarly, while use of calibration system 602 could arise in calibration errors due to potential mismatch between unshared components of the combined signal path 365-f and the WWAN feedback path 615 (of FIG. 6B), in the calibration system 702, the potential for calibration errors is once again reduced by simultaneously using the WLAN feedback path 530-b and the WWAN feedback path 615-b.

For example, in the calibration system 702, combined signal path 365-g uses a greater number of components in the WWAN transceiver than in the WLAN transceiver. Thus, during calibration, the amount of calibration determined by using the WWAN feedback path 615-b may be given a greater weight than the amount of calibration determined by using the WLAN feedback path 530-b. Alternatively, feedback path calibration weighting may be based on not only the number of components used in each transceiver by the combined signal path 365-g, but also by the type of components used in each transceiver by the combined signal path 365-g. For example, if certain components are known to contribute more noise than other components (and thus require more calibration), the feedback path that includes the most noisy components can be accorded greater weight. Therefore, calibration amounts determined at both the WWAN digital BB chain 305-g and the WLAN digital BB chain 335-g may be combined via a weighted summing operation.

Further, the WLAN feedback path 530-b may be calibrated with respect to the WWAN feedback path 615-b. In this way, even though WWAN signals may be propagated along the WLAN feedback path 530-b, the WLAN feedback path 530-b need not be modified for the WWAN signals. Instead, calibration results determined at the WLAN feedback path 530-b may be scaled or weighted with respect to the calibration results determined at the WWAN feedback path 615-b in order to account for WWAN-related differences.

While calibration system 702 has been illustrated with respect to a specific combined signal path 365-g, calibration system 702 may also be used in connection with other combined signal paths by using both the WLAN feedback path 530-b and the WWAN feedback path 615-b in calibrating the combined signal path. Additionally, while calibration system 702 has been illustrated with couplers 520-b, 525-b, other methods of coupling the combined signal path 365-g with the WLAN feedback path 530-a and with the WWAN feedback path 615-a may be used. For example, coupling between the combined signal path 365-g and the WLAN feedback path 530-a and WWAN feedback path 615-a may be accomplished using an antenna path, a cable, a switch, a coupler, or via combinations of the same.

The calibration systems 500, 502, 600, 602, 700, and 702 of FIGS. 5A, 5B, 6A, 6B, 7A, and 7B, respectively, may be used while the UE 115 is itself being used (as an online or runtime calibration) or may be used during factory calibration.

Additionally, while the calibration systems 500, 502, 600, 602, 700, and 702 of FIGS. 5A, 5B, 6A, 6B, 7A, and 7B, respectively, are illustrated as including couplers 505, 510, 520, 525 and switch 605, in certain circumstances, the couplers 505, 510, 520, 525 and switch 605 may not be necessary. For example, during online calibration, couplers 505, 510, 520, 525 and switch 605 may be used. However, instead of using the couplers 505, 510, 520, 525 and switch 605, over-the-air calibration may also be used, where a signal from the combined signal path is actually transmitted through an antenna to, for example, a base station 105 and then routed back to one or more antennas of the UE 115 for processing through one or more feedback paths of the UE 115. During factory calibration, cable connections facilitated by a calibration unit separate from the UE 115 may be used. The cable connections may facilitate a cable crossover between an input/output used by a combined signal path and a feedback path used to calibrate the combined signal path.

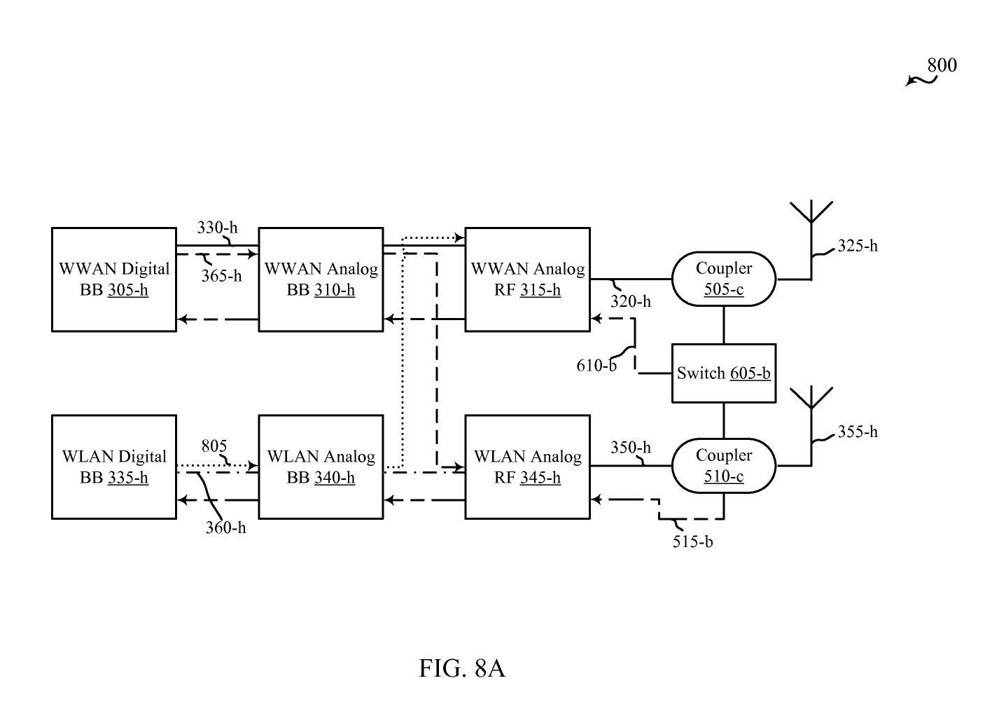

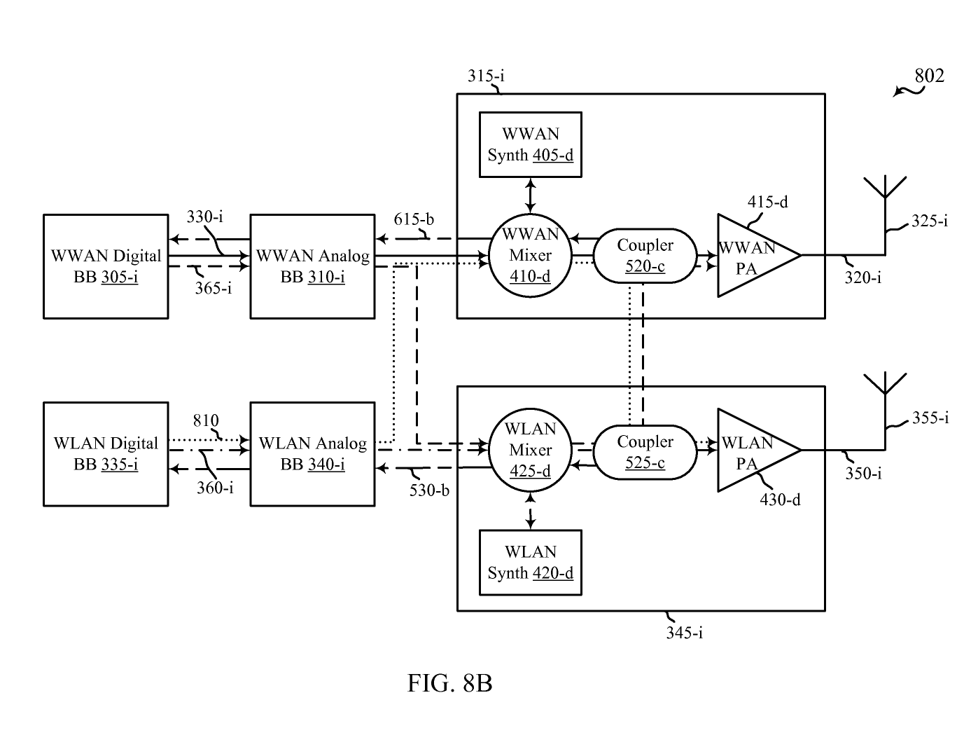

FIG. 8A shows an additional example calibration system 800 for a combined signal path that uses both WWAN and WLAN transceivers. The example calibration system 800 illustrates one possible calibration option for a combined signal path as described in system 300 of FIG. 3. Additionally, the calibration system 800 may also be used in connection with other combined signal paths.

Calibration system 800 addresses potential mismatches in feedback paths arising from signal leakage. For example, because a feedback path and a Tx signal path may share certain transceiver components, there is a potential for Tx signal leakage from the Tx signal path to the feedback path. The Tx signal path leakage thus results in increased noise in the feedback path. Tx signal path leakage is generally unique to each signal path. Thus, a WWAN Tx signal path may result in Tx signal path leakage that is different from that resulting from a WLAN Tx signal path. Generally, high Tx signal power results in greater signal leakage. This asymmetric noise leakage on WWAN and WLAN feedback paths may impact relative calibration results. Thus, calibration system 800 includes the use of additional Tx signal paths to reduce the impact of noise leakage during calibration.

Calibration system 800 illustrates a system for calibrating combined signal path 365-e and combined signal path 805 that each use portions of a WWAN transceiver and portions of a WLAN transceiver. The WWAN transceiver may include a WWAN digital BB chain 305-h, a WWAN analog BB chain 310-h, and a WWAN analog RF chain 315-h. A typical WWAN signal path 330-h is illustrated as passing through the WWAN digital BB chain 305-h, the WWAN analog BB chain 310-h, and the WWAN analog RF chain 315-h. The typical WWAN signal path 330-h includes input/output 320-h and antenna 325-h, which may be a WWAN antenna.

The WLAN transceiver may include a WLAN digital BB chain 335-h, a WLAN analog BB chain 340-h, and a WLAN analog RF chain 345-h. A typical WLAN signal path 360-h is illustrated as passing through the WLAN digital BB chain 335-h, the WLAN analog BB chain 340-h, and the WLAN analog RF chain 345-h. The typical WLAN signal path 360-h includes input/output 350-h and antenna 355-h, which may be a WLAN antenna.

A combined signal path 365-h is illustrated as flowing through the WWAN digital BB chain 305-h and the WWAN analog BB chain 310-h of the WWAN transceiver. Instead of using the WWAN analog RF chain 315-h, the combined signal path 365-h uses the WLAN analog RF chain 345-h. In the example of FIG. 8A, the combined signal path 365-h would also use input/output 350-h and antenna 355-h.

As in the calibration system 700 (of FIG. 7A), the calibration system 800 also includes couplers 505-c, 510-c, and switch 605-b to facilitate the coupling of the combined signal path 365-h to both the WLAN feedback path 515-b and the WWAN feedback path 610-b. Thus, the combined signal path 365-h may be calibrated using both the WLAN feedback path 515-b and the WWAN feedback path 610-b. Calibration processing may occur at both the WLAN digital BB chain 335-h and the WWAN digital BB chain 305-h. However, signal leakage from the combined signal path 365-h may affect both the WLAN feedback path 515-b and the WWAN feedback path 610-b and the resultant calibration processing. In order to account for this, an additional combined signal path may be used.

For example, the calibration system 800 includes an additional combined signal path 805. Combined signal path 805 is illustrated as flowing through the WLAN digital BB chain 335-h and the WLAN analog BB chain 340-h of the WLAN transceiver. Instead of using the WLAN analog RF chain 345-h, the combined signal path 805 uses the WWAN analog RF chain 315-h. In the example of FIG. 8A, the combined signal path 805 would also use input/output 320-h and antenna 325-h. The combined signal path 805 may be coupled to both the WLAN feedback path 515-b and the WWAN feedback path 610-b using the couplers 505-c, 510-c, and switch 605-b. While not explicitly shown, the coupling between the combined signal path 805 and the WWAN feedback path 610-b may be made directly using the coupler 505-c. The coupling between the combined signal path 805 and the WLAN feedback path 515-b may be made using the coupler 505-c and the switch 605-b. Thus, like the combined signal path 365-h, the combined signal path 805 may be calibrated using both the WLAN feedback path 515-b and the WWAN feedback path 610-b.

By calibrating two (or more) combined signal paths using the same WLAN feedback path 515-b and WWAN feedback path 610-b, the effect of signal leakage from the combined signal paths may be reduced. For example, because one of the combined signal paths 365-h of calibration system 800 uses the WLAN analog RF chain 345-h, and because the other of the combined signal paths 805 (of calibration system 800) uses the WWAN analog RF chain 315-h, the amount of noise (including that arising from signal leakage) that occurs in either the WWAN analog RF chain 315-h or the WLAN analog RF chain 345-h may be determined with respect to each of the combined signal paths 365-h, 805. Similarly, in the example of calibration system 800, the noise arising from WWAN digital BB chain 305-h and WWAN analog BB chain 310-h may be compared with the noise arising from WLAN digital BB chain 335-h and WLAN analog BB chain 340-h. By the comparison, the relative amounts of noise may be determined and the calibration of each of the combined signal paths 365-h, 805 may be refined.

Additional combined signal paths may be introduced into the calibration system 800 in order to further refine the calibration process. Additional combined signal paths may allow for an even more precise determination of noise arising from specific components of the WWAN and WLAN transceivers.

As described above, the calibration may be performed while the UE 115 is itself being used (as an online or runtime calibration) or may be performed during factory calibration. The couplers 505-c, 510-c and switch 605-b may be used during online calibration. Alternatively, over-the-air calibration may not require the use of the couplers 505-c, 510-c and switch 605-b. Cables, in connection with a separate calibration unit (such as a test jig) may perform the role of the couplers 505-c, 510-c and switch 605-b during factory calibration. The cables may facilitate a cable crossover between an input/output used by a combined signal path and a feedback path used to calibrate the combined signal path.

FIG. 8B shows yet another example calibration system 802 for a combined signal path that uses both WWAN and WLAN transceivers. The example calibration system 802 illustrates one possible calibration option for a combined signal path as described in system 400 of FIG. 4. Additionally, the calibration system 802 may also be used in connection with other combined signal paths.

Like calibration system 800 of FIG. 8A, calibration system 802 addresses potential mismatches in feedback paths arising from signal leakage. The asymmetric noise leakage on WWAN and WLAN feedback paths may impact relative calibration results. Thus, calibration system 802 includes the use of additional Tx signal paths to reduce the impact of noise leakage during calibration.

Calibration system 802 illustrates a system for calibrating combined signal path 365-i that uses portions of a WWAN transceiver and portions of a WLAN transceiver. The WWAN transceiver may include a WWAN digital BB chain 305-i, a WWAN analog BB chain 310-i, and a WWAN analog RF chain 315-i. The WWAN analog RF chain 315-i may further include a WWAN synthesizer 405-d, a WWAN mixer 410-d, and a WWAN PA 415-d. A typical WWAN signal path 330-i is illustrated as passing through the WWAN digital BB chain 305-i, the WWAN analog BB chain 310-i, and the WWAN analog RF chain 315-i. In the WWAN analog RF chain 315-i, the WWAN signal path 330-i is processed using the WWAN synthesizer 405-d, the WWAN mixer 410-d, and the WWAN PA 415-d. The WWAN signal path 330-i includes input/output 320-i and antenna 325-i, which may be a WWAN antenna.

The WLAN transceiver may include a WLAN digital BB chain 335-i, a WLAN analog BB chain 340-i, and a WLAN analog RF chain 345-i. The WLAN analog RF chain 345-i may further include a WLAN synthesizer 420-d, a WLAN mixer 425-d, and a WLAN PA 430-d. A typical WLAN signal path 360-i is illustrated as passing through the WLAN digital BB chain 335-i, the WLAN analog BB chain 340-i, and the WLAN analog RF chain 345-i. In the WLAN analog RF chain 345-i, the WLAN signal path 360-i is processed using the WLAN synthesizer 420-d, the WLAN mixer 425-d, and the WLAN PA 430-d. The typical WLAN signal path 360-i includes input/output 350-i and antenna 355-i, which may be a WLAN antenna.

The combined signal path 365-i is illustrated as flowing through the WWAN digital BB chain 305-i and the WWAN analog BB chain 310-i of the WWAN transceiver. However, instead of using the entirety of the WWAN analog RF chain 315-i, the combined signal path 365-i uses a portion of the WLAN analog RF chain 345-i. Specifically, in the example of FIG. 8B, the combined signal path 365-i uses the WLAN mixer 425-d and the WLAN synthesizer 420-d of the WLAN analog RF chain 345-i and the WWAN PA 415-d of the WWAN analog RF chain 315-i. In the example of FIG. 8B, the combined signal path 365-i would also use input/output 320-i and antenna 325-i.

As in the calibration system 702 (of FIG. 7B), the calibration system 802 also includes couplers 520-c, 525-c to facilitate the coupling of the combined signal path 365-i to both the WLAN feedback path 530-b and the WWAN feedback path 615-b. Thus, the combined signal path 365-i may be calibrated using both the WLAN feedback path 530-b and the WWAN feedback path 615-b. Calibration processing may occur at both the WLAN digital BB chain 335-i and the WWAN digital BB chain 305-i. However, signal leakage from the combined signal path 365-i may affect both the WLAN feedback path 530-b and the WWAN feedback path 615-b and the resultant calibration processing. In order to account for this, an additional combined signal path may be used.

For example, the calibration system 802 includes an additional combined signal path 810. Combined signal path 810 is illustrated as flowing through the WLAN digital BB chain 335-i and the WLAN analog BB chain 340-i of the WLAN transceiver. Instead of using the entirety of the WLAN analog RF chain 345-i, the combined signal path 810 uses a portion of the WWAN analog RF chain 315-i. Specifically, in the example of FIG. 8B, the combined signal path 810 uses the WWAN mixer 410-d and the WWAN synthesizer 405-d of the WWAN analog RF chain 315-i and the WLAN PA 430-d of the WLAN analog RF chain 345-i. In the example of FIG. 8B, the combined signal path 810 would also use input/output 350-i and antenna 355-i. The combined signal path 810 may be coupled to both the WLAN feedback path 530-b and the WWAN feedback path 615-b using the couplers 520-c, 525-c. Thus, like the combined signal path 365-i, the combined signal path 810 may be calibrated using both the WLAN feedback path 530-b and the WWAN feedback path 615-b.

By calibrating two (or more) combined signal paths using the same WLAN feedback path 530-b and WWAN feedback path 615-b, the effect of signal leakage from the combined signal paths may be reduced. For example, because one of the combined signal paths 365-i of calibration system 802 uses the WLAN mixer 425-d, and because the other of the combined signal paths 810 (of calibration system 802) uses the WWAN mixer 410-d, the amount of noise (including that arising from signal leakage) that occurs in either the WWAN mixer 410-d or the WLAN mixer 425-d may be determined with respect to each of the combined signal paths 365-i, 810. Similarly, in the example of calibration system 802, the noise arising from WWAN digital BB chain 305-i and WWAN analog BB chain 310-i may be compared with the noise arising from WLAN digital BB chain 335-i and WLAN analog BB chain 340-i. By the comparison, the relative amounts of noise may be determined and the calibration of each of the combined signal paths 365-i, 810 may be refined.

Additional combined signal paths may be introduced into the calibration system 802 in order to further refine the calibration process. Additional combined signal paths may allow for an even more precise determination of noise arising from specific components of the WWAN and WLAN transceivers.

As described above, the calibration may be performed while the UE 115 is itself being used (as an online or runtime calibration) or may be performed during factory calibration. The couplers 520-c, 525-c may be used during online calibration. Alternatively, over-the-air calibration may not require the use of the couplers 520-c, 525-c. Cables, in connection with a separate calibration unit (such as a test jig) may perform the role of the couplers 520-c, 525-c during factory calibration. The cables may facilitate a cable crossover between an input/output used by a combined signal path and a feedback path used to calibrate the combined signal path.

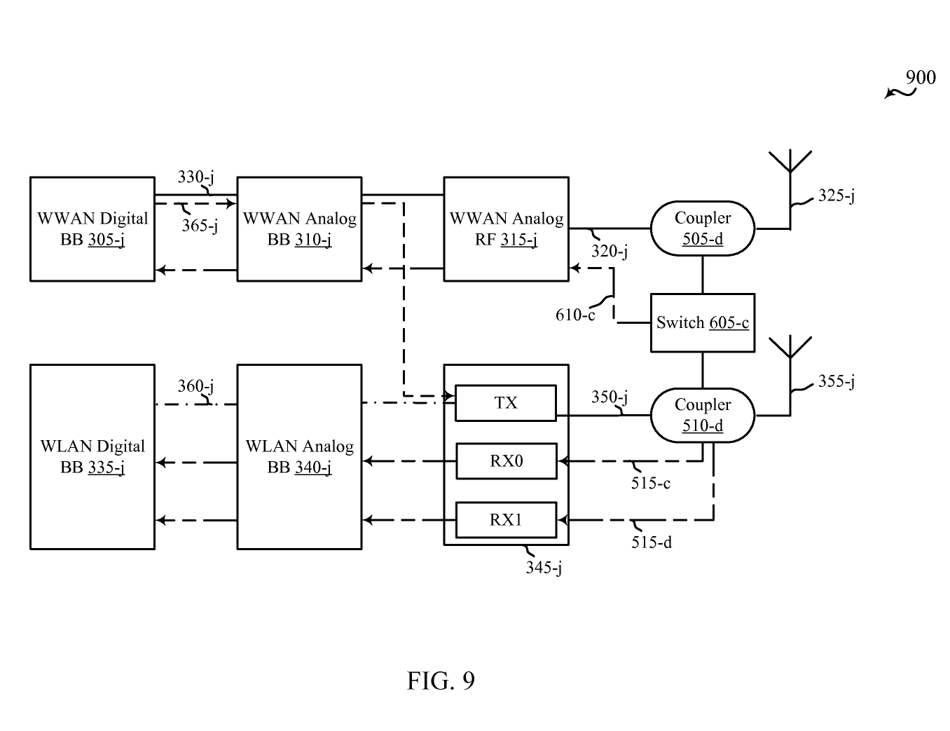

Potential asymmetry across different feedback paths within the same transceiver may also be corrected. FIG. 9 shows an example calibration system 900 for a combined signal path that uses both WWAN and WLAN transceivers and which has multiple WLAN feedback paths (corresponding to multiple WLAN Rx chains). The example calibration system 900 illustrates one possible calibration option for a combined signal path as described in system 300 of FIG. 3. Additionally, the calibration system 900 may also be used in connection with other combined signal paths.

Calibration system 900 illustrates a system for calibrating combined signal path 365-j that uses portions of a WWAN transceiver and portions of a WLAN transceiver. The WWAN transceiver may include a WWAN digital BB chain 305-j, a WWAN analog BB chain 310-j, and a WWAN analog RF chain 315-j. A typical WWAN signal path 330-j is illustrated as passing through the WWAN digital BB chain 305-j, the WWAN analog BB chain 310-j, and the WWAN analog RF chain 315-j. The typical WWAN signal path 330-j includes input/output 320-j and antenna 325-j, which may be a WWAN antenna.

The WLAN transceiver may include a WLAN digital BB chain 335-j, a WLAN analog BB chain 340-j, and a WLAN analog RF chain 345-j. A typical WLAN signal path 360-j is illustrated as passing through the WLAN digital BB chain 335-j, the WLAN analog BB chain 340-j, and the WLAN analog RF chain 345-j. The typical WLAN signal path 360-j includes input/output 350-j and antenna 355-j, which may be a WLAN antenna.

A combined signal path 365-j is illustrated as flowing through the WWAN digital BB chain 305-j and the WWAN analog BB chain 310-j of the WWAN transceiver. Instead of using the WWAN analog RF chain 315-j, the combined signal path 365-j uses the WLAN analog RF chain 345-j. In the example of FIG. 9, the combined signal path 365-j would also use input/output 350-j and antenna 355-j.

As in the calibration system 700 (of FIG. 7A), the calibration system 900 also includes couplers 505-d, 510-d, and switch 605-c to facilitate the coupling of the combined signal path 365-j to both the WLAN feedback path 515-c and the WWAN feedback path 610-c. Additionally, coupler 510-d also facilitated the coupling of the combined signal path 365-j to other WLAN feedback paths, such as WLAN feedback path 515-d. Similarly, the combined signal path 365-j may be coupled to more than one WWAN feedback path (not shown). The coupling of the combined signal path 365-f to multiple feedback paths allows for any asymmetry across the different feedback paths to be compared and calibrated.

While calibration system 900 has been illustrated with respect to a specific combined signal path 365-j, calibration system 900 may also be used in connection with other combined signal paths. For example, calibration system 900 may be used in connection with system 400 of FIG. 4.

As described above, the calibration may be performed while the UE 115 is itself being used (as an online or runtime calibration) or may be performed during factory calibration. The couplers 505-d, 510-d and switch 605-c may be used during online calibration. Alternatively, over-the-air calibration may not require the use of the couplers 505-d, 510-d and switch 605-c. Cables, in connection with a separate calibration unit (such as a test jig) may perform the role of the couplers 505-d, 510-d and switch 605-c during factory calibration. The cables may facilitate a cable crossover between an input/output used by a combined signal path and a feedback path used to calibrate the combined signal path.

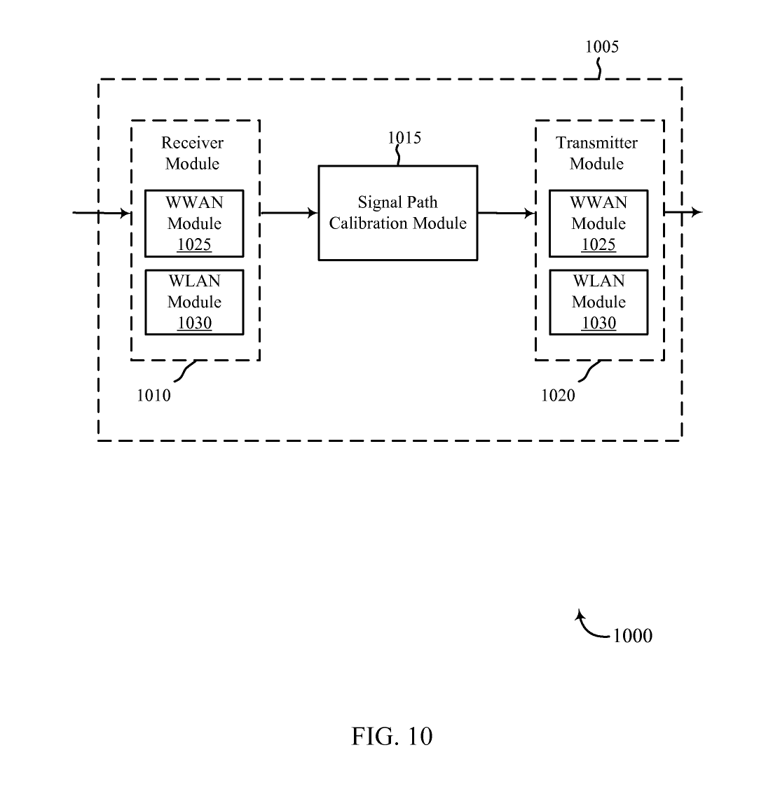

FIG. 10 shows a block diagram 1000 of an apparatus 1005 for use in a wireless device for wireless communication, in accordance with various aspects of the present disclosure. In some examples, the apparatus 1005 may be an example of aspects of one or more of the wireless devices 115 described with reference to FIG. 1. The apparatus 1005 may also be or include a processor (not shown). The apparatus 1005 may include a receiver module 1010, a signal path calibration module 1015, and a transmitter module 1020. Each of these modules may be in communication with each other. The receiver module 1010 and the transmitter module 1020 may be combined as a single transceiver module. Additionally, the apparatus 1005 may include multiple receiver modules 1010, transmitter modules 1020, either separately or as combined transceiver modules.

The apparatus 1005, through the receiver module 1010, the signal path calibration module 1015, or the transmitter module 1020, may be configured to perform functions described herein. For example, the apparatus 1005 may be configured to provide calibration of signal paths that use portions of both a WWAN transceiver and a WLAN transceiver. The calibration may be performed while the apparatus 1005 is online or during factory calibration. The calibration may be for one or more combined signal paths used by the apparatus 1005.

The components of the apparatus 1005 may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by one or more general or application-specific processors.

The receiver module 1010 may receive information such as packets, user data, and/or control information associated with various information channels (e.g., control channels, data channels, etc.). The receiver module 1010 may include both a WWAN module 1025 and a WLAN module 1030. The receiver module 1010 may be combined with the transmitter module 1020 to form a transceiver that includes both WWAN and WLAN transceivers. The receiver module 1010 may be configured to include one or more combined signal paths that each use portions of both the WWAN module 1025 and the WLAN module 1030. The receiver module 1010 may also include at least one WWAN feedback path, at least one WLAN feedback path, or a combination of both WWAN and WLAN feedback paths. The feedback paths may be used to calibrate, for example combined transmit signal paths (of the transmitter module 1020). The combined signal paths of the receiver module 1010 may be calibrated using feedback paths of the transmitter module 1020. Calibration of the combined signal paths may be facilitated by the signal path calibration module 1015, which may be a part of the receiver module 1010, the transmitter module 1020, or both (including when the receiver module 1010 and the transmitter module 1020 are in the form of one or more transceivers).

The signal path calibration module 1015 may be configured to calibrate the combined signal paths of the receiver module 1010 and of the transmitter module 1020. The combined signal paths may be combined Tx signal paths, combined Rx signal paths, or both. Calibration may be facilitated by using either one or more WWAN feedback paths, one or more WLAN feedback paths, or both. Calibration results using one or more feedback paths may be combined to determine an overall calibration. Combining calibration results may involve using a weighted sum of individual calibration results. While the features and operations of the signal path calibration module 1015 are described separately with regard to FIG. 10, the signal path calibration module 1015 and its operations may be combined with either the receiver module 1010, the transmitter module 1020, or both. For example, the operations of the signal path calibration module 1015 may be performed within a digital BB chain of either the WWAN module 1025 or the WLAN module 1030.

The transmitter module 1020 may transmit the one or more signals received from other components of the apparatus 1005. The transmitter module 1020 may include both the WWAN module 1025 and the WLAN module 1030 that are also included in the receiver 1010. The transmitter module 1020 may be combined with the receiver module 1010 to form a transceiver that includes both WWAN and WLAN transceivers. The transmitter module 1020 may be configured to include one or more combined signal paths that each use portions of both the WWAN module 1025 and the WLAN module 1030. The transmitter module 1020 may also include at least one WWAN feedback path, at least one WLAN feedback path, or a combination of both WWAN and WLAN feedback paths. The feedback paths may be used to calibrate, for example combined receive signal paths (of the receiver module 1010). The combined signal paths of the transmitter module 1020 may be calibrated using feedback paths of the receiver module 1010. Calibration of the combined signal paths may be facilitated by the signal path calibration module 1015, which may be a part of the transmitter module 1020, the receiver module 1010, or both (including when the transmitter module 1020 and the receiver module 1010 are in the form of one or more transceivers).

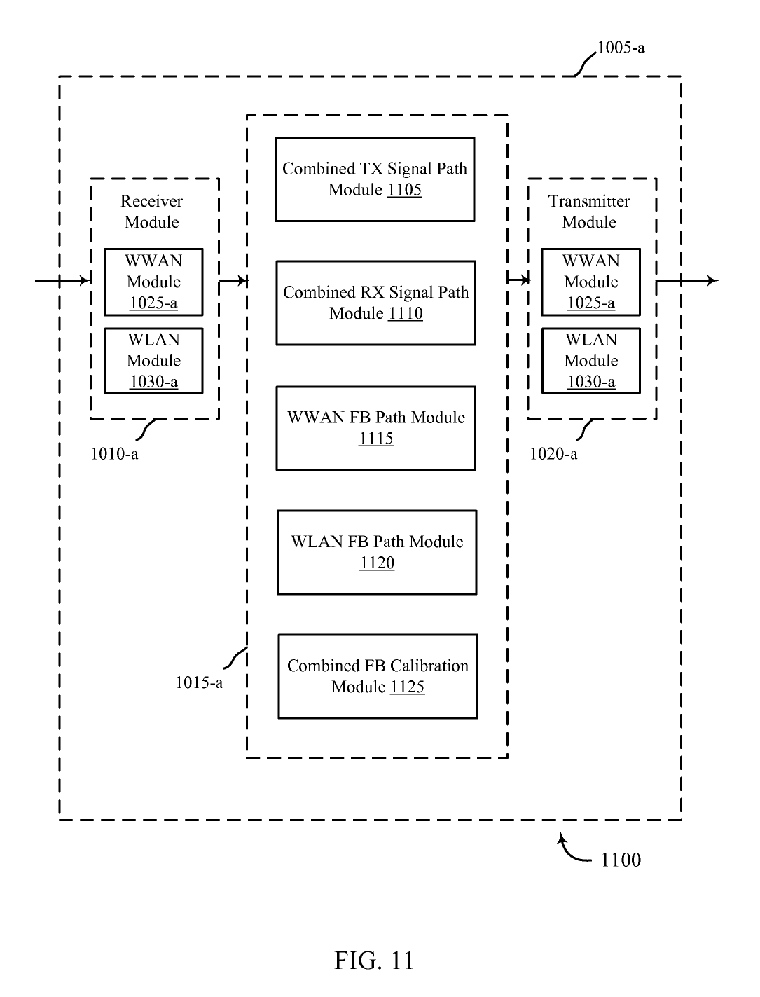

FIG. 11 shows a block diagram 1100 of an apparatus 1005-a that is used in a wireless device for wireless communication, in accordance with various examples. The apparatus 1005-a may be an example of one or more aspects of a wireless device 115 described with reference to FIG. 1. It may also be an example of an apparatus 1005 described with reference to FIG. 10. The apparatus 1005-a may include a receiver module 1010-a, a signal path calibration module 1015-a, and a transmitter module 1020-a, which may be examples of the corresponding modules of apparatus 1005. The apparatus 1005-a may also include a processor (not shown). Each of these modules may be in communication with each other. The signal path calibration module 1015-a may include a combined Tx signal path module 1105, a combined Rx signal path module 1110, a WWAN feedback path module 1115, a WLAN feedback path module 1120, and a combined RB calibration module 1125. The receiver module 1010-a and the transmitter module 1020-a may each include at least one WWAN module 1025-a and at least one WLAN module 1030-a, and may be combined as one or more transceivers. The receiver module 1010-a and the transmitter module 1020-a may perform the functions of the receiver module 1010 and the transmitter module 1020, of FIG. 10, respectively.

The combined Tx signal path module 1105 may be used to determine or select a combined Tx signal path that uses portions of at least one WWAN module 1025-a and at least one WLAN module 1030-a. The apparatus 1005-a may include a combined Tx signal path in the transmitter module 1020-a. The combined Tx signal path may be predetermined or may be selected from among more than one combined Tx signal path. The combined Tx signal path module 1105 may store information relating to which components of the WWAN module 1025-a and which components of the WLAN module 1030-a are included in each combined Tx signal path in apparatus 1005-a. The stored information may be used by the combined feedback calibration module 1125 to facilitate calibration of one or more of the combined Tx signal paths in the apparatus 1005-a.

The combined Rx signal path module 1110 may be used to determine or select a combined Rx signal path that uses portions of at least one WWAN module 1025-a and at least one WLAN module 1030-a. The apparatus 1005-a may include a combined Rx signal path in the receiver module 1010-a. The combined Rx signal path may be predetermined or may be selected from among more than one combined Rx signal path. The combined Rx signal path module 1110 may store information relating to which components of the WWAN module 1025-a and which components of the WLAN module 1030-a are included in each combined Rx signal path in apparatus 1005-a. The stored information may be used by the combined feedback calibration module 1125 to facilitate calibration of one or more of the combined Rx signal paths in the apparatus 1005-a.

The WWAN feedback path module 1115 may be used to determine or select a WWAN feedback path to be used to calibrate a combined signal path (either a combined Tx signal path or a combined Rx signal path). The WWAN feedback path may be predetermined or may be selected from among more than one WWAN feedback path. The WWAN feedback path module 1115 may store information relating to which components of the WWAN module 1025-a are included in each WWAN feedback path in apparatus 1005-a. The stored information may be used by the combined feedback calibration module 1125 to facilitate calibration of one or more of the combined Tx or combined Rx signal paths in the apparatus 1005-a.

The WLAN feedback path module 1120 may be used to determine or select a WLAN feedback path to be used to calibrate a combined signal path (either a combined Tx signal path or a combined Rx signal path). The WLAN feedback path may be predetermined or may be selected from among more than one WLAN feedback path. The WLAN feedback path module 1120 may store information relating to which components of the WLAN module 1030-a are included in each WLAN feedback path in apparatus 1005-a. The stored information may be used by the combined feedback calibration module 1125 to facilitate calibration of one or more of the combined Tx or combined Rx signal paths in the apparatus 1005-a.

The combined feedback calibration module 1125 may be used to calibrate one or more of the combined Tx signal paths determined by the combined Tx signal path module 1105 or one or more of the combined Rx signal paths determined by the combined Rx signal path module 1110 by using WWAN feedback paths and WLAN feedback paths determined by the WWAN feedback path module 1115 and the WLAN feedback path module 1120. The combined feedback calibration module 1125 may be included as part of a digital BB chain of either or both of the WWAN module 1025-a and the WLAN module 1030-a. The combined feedback calibration module 1125 may perform calibration processing to determine the amount of calibration that may be applied after consideration of a feedback path. The combined feedback calibration module 1125 may also perform calibration processing to determine a summed amount of calibration that may be applied after consideration of multiple feedback paths. The summed amount of calibration may be a weighted summation. The weighting of each calibration amount may be applied by the combined feedback calibration module 1125 based on the components used by any combined Tx signal paths (as stored by the combined Tx signal path module 1105), by any combined Rx signal paths (as stored by the combined Rx signal path module 1110), and by any WWAN and/or WLAN feedback paths (as stored by the WWAN feedback path module 1115 and by the WLAN feedback path module 1120, respectively). The combined feedback calibration module 1125 may be used to calibrate multiple combined signal paths, and may use multiple feedback paths, even from the same WWAN module 1025-a or WLAN module 1030-a.

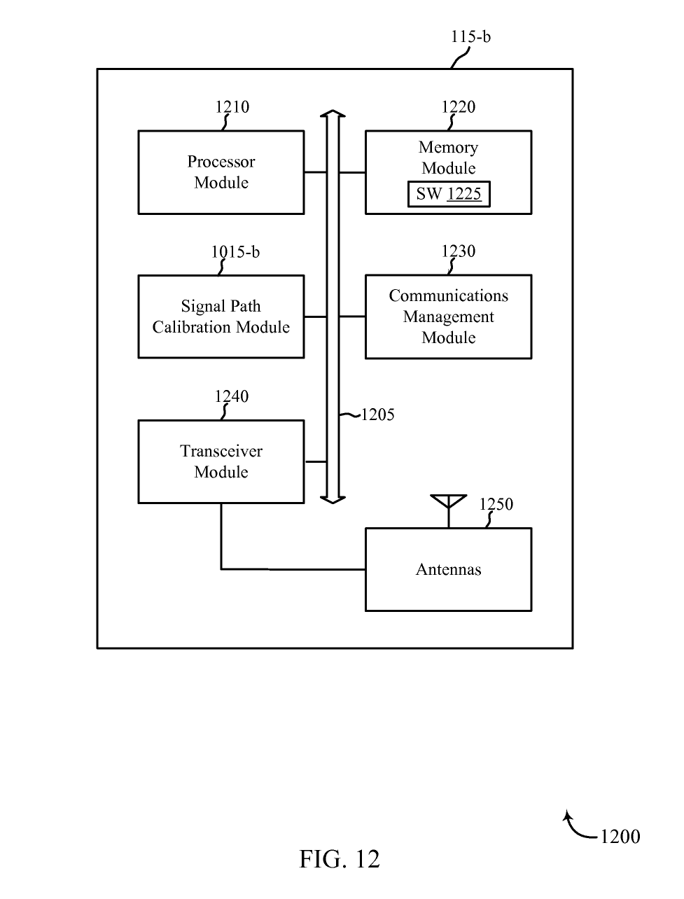

Turning to FIG. 12, a diagram 1200 is shown that illustrates a UE 115-b configured to include at least one combined signal path for either transmission or reception, and to calibrate that at least one combined signal path. The UE 115-b may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The UE 115-b may have an internal power supply (not shown), such as a small battery, to facilitate mobile operation. The UE 115-b may be an example of the UEs 115 of FIG. 1 and/or the apparatus 1005 of FIGS. 10 and 11.

The UE 115-b may include a processor module 1210, a memory module 1220, a transceiver module 1240, antennas 1250, and a signal path calibration module 1015-b. The signal path calibration module 1015-b may be an example of the signal path calibration module 1015 of FIGS. 10 and 11. Each of these modules may be in communication with each other, directly or indirectly, over at least one bus 1205.

The memory module 1220 may include RAM and ROM. The memory module 1220 may store computer-readable, computer-executable software (SW) code 1225 containing instructions that are configured to, when executed, cause the processor module 1210 to perform various functions described herein for calibrating one or more combined signal paths in the transceiver module 1240. Alternatively, the software code 1225 may not be directly executable by the processor module 1210, but be configured to cause the computer (e.g., when compiled and executed) to perform functions described herein.

The processor module 1210 may include an intelligent hardware device, e.g., a CPU, a microcontroller, an ASIC, etc. The processor module 1210 may process information received through the transceiver module 1240 and/or to be sent to the transceiver module 1240 for transmission through the antennas 1250. The processor module 1210 may handle, alone or in connection with the signal path calibration module 1015-b and the transceiver module 1240, various aspects for calibrating combined signal paths that use portions of both WWAN and WLAN transceivers included in the transceiver module 1240.

The transceiver module 1240 may be configured to communicate bi-directionally with APs 110/base stations 105 in FIG. 1. The transceiver module 1240 may be implemented as at least one transmitter module and at least one separate receiver module, or may be combined as one or more transceivers. The transceiver module 1240 may include a modem configured to modulate the packets and provide the modulated packets to the antennas 1250 for transmission, and to demodulate packets received from the antennas 1250. The UE 115-b may include multiple antennas 1250 corresponding to the capabilities of the transceiver module 1240. For example, the transceiver module 1240 may include at least one WWAN transceiver and at least one WLAN transceiver. Antennas 1250 may correspond to the at least one WWAN transceiver and the at least one WLAN transceiver.

According to the architecture of FIG. 12, the UE 115-b may further include a communications management module 1230. The communications management module 1230 may manage communications with various APs/base stations. The communications management module 1230 may be a component of the UE 115-b in communication with some or all of the other components of the UE 115-b over the at least one bus 1205. Alternatively, functionality of the communications management module 1230 may be implemented as a component of the transceiver module 1240, as a computer program product, and/or as at least one controller element of the processor module 1210.

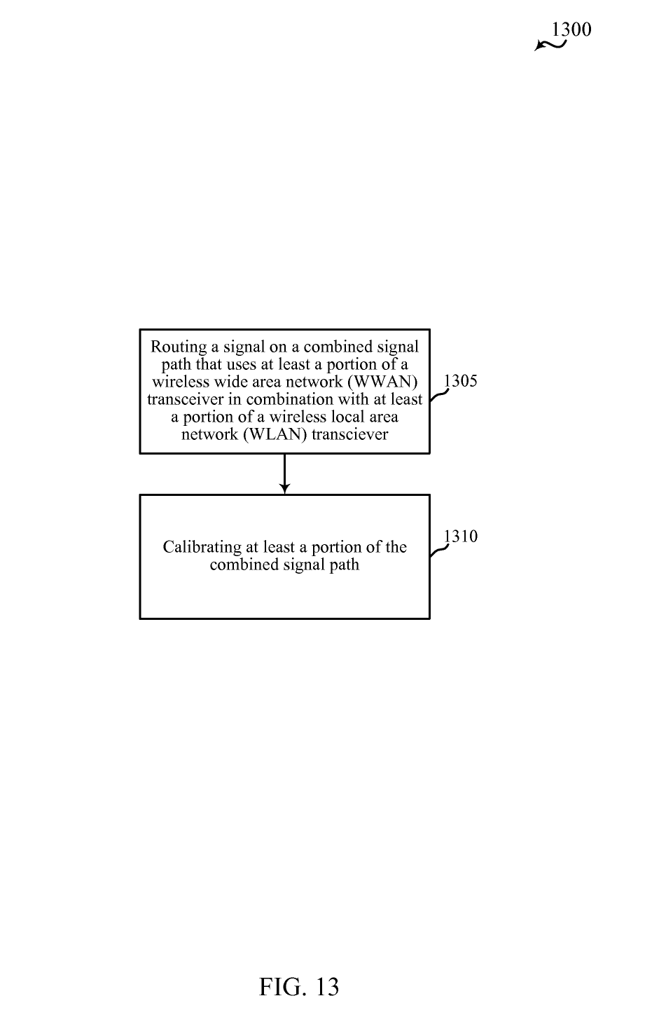

The components of the UE 115-b may be configured to implement aspects discussed above with respect to FIGS. 2-11, and those aspects may not be repeated here for the sake of brevity. Moreover, the components of the UE 115-b may be configured to implement aspects discussed below with respect to FIGS. 13-16, and those aspects may not be repeated here also for the sake of brevity.

FIG. 13 is a flow chart illustrating an example of a method 1300 for wireless communication, in accordance with various aspects of the present disclosure. For clarity, the method 1300 is described below with reference to aspects of one or more of the UEs 115 described with reference to FIGS. 1 and 12, aspects of one or more of the systems described with reference to FIGS. 2-9, and/or aspects of one or more of the apparatuses described with reference to FIGS. 10 and 11. In some examples, a UE 115 may execute one or more sets of codes to control the functional elements of the UE 115 to perform the functions described below. Additionally or alternatively, the UE 115 may perform one or more of the functions described below using-purpose hardware.

At block 1305, the method 1300 may include routing a signal on a combined signal path that uses at least a portion of a WWAN transceiver in combination with at least a portion of a WLAN transceiver. The combined signal path may be either a combined Tx signal path or a combined Rx signal path.

The operations at block 1305 may be performed using at least the combined Tx signal path module 1105 and/or the combined Rx signal path module 1110 described with reference to FIG. 11.

At block 1310, the method 1300 may include calibrating at least a portion of the combined signal path. Calibration may occur using either a WWAN feedback path or a WLAN feedback path or both. Calibration may occur online or in a factory (using a separate calibration unit, such as a test jig). Calibration may be accomplished using couplers and switches, over-the-air, or via cabling to route the signal from the combined signal path to one or more of a WWAN feedback path and a WLAN feedback path.

The operations at block 1310 may be performed using at least the WWAN feedback path module 1115, the WLAN feedback path module 1120, and/or the combined feedback calibration module 1125 described with reference to FIG. 11.

Thus, the method 1300 may provide for wireless communication. It should be noted that the method 1300 is just one implementation and that the operations of the method 1300 may be rearranged or otherwise modified such that other implementations are possible.

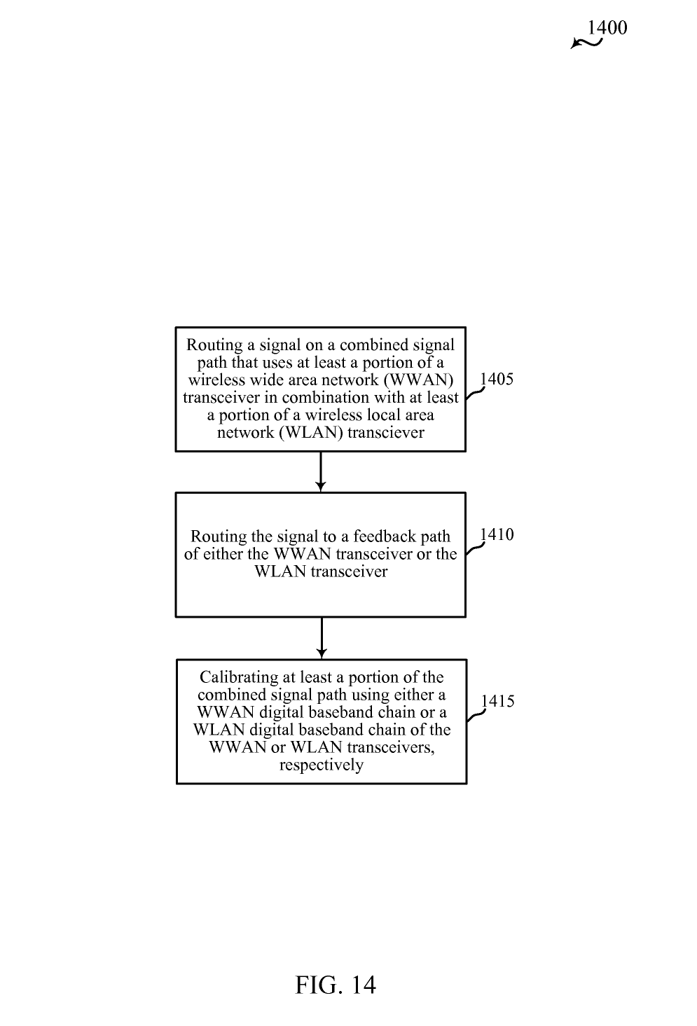

FIG. 14 is a flow chart illustrating an example of a method 1400 for wireless communication, in accordance with various aspects of the present disclosure. For clarity, the method 1400 is described below with reference to aspects of one or more of the UEs 115 described with reference to FIGS. 1 and 12, aspects of one or more of the systems described with reference to FIGS. 2-6, and/or aspects of one or more of the apparatuses described with reference to FIGS. 10 and 11. In some examples, a UE 115 may execute one or more sets of codes to control the functional elements of the UE 115 to perform the functions described below. Additionally or alternatively, the UE 115 may perform one or more of the functions described below using-purpose hardware.

At block 1405, the method 1400 may include routing a signal on a combined signal path that uses at least a portion of a WWAN transceiver in combination with at least a portion of a WLAN transceiver. The combined signal path may be either a combined Tx signal path or a combined Rx signal path.

The operations at block 1405 may be performed using at least the combined Tx signal path module 1105 and/or the combined Rx signal path module 1110 described with reference to FIG. 11.

At block 1410, the method 1400 may include routing the signal to a feedback path of either the WWAN transceiver or the WLAN transceiver. Thus, calibration may occur using either a WWAN feedback path or a WLAN feedback path.

The operations at block 1410 may be performed using at least the WWAN feedback path module 1115 and/or the WLAN feedback path module 1120 described with reference to FIG. 11.

At block 1415, the method 1400 may include calibrating at least a portion of the combined signal path using either a WWAN digital baseband chain or a WLAN digital baseband chain of the WWAN or WLAN transceivers, respectively. Thus, calibration may occur using either a WWAN feedback path or a WLAN feedback path. Calibration may occur online or in a factory (using a separate calibration unit, such as a test jig). Calibration may be accomplished using couplers and switches, over-the-air, or via cabling to route the signal from the combined signal path to either a WWAN feedback path or a WLAN feedback path.

The operations at block 1415 may be performed using at least the combined feedback calibration module 1125 described with reference to FIG. 11.

Thus, the method 1400 may provide for wireless communication. It should be noted that the method 1400 is just one implementation and that the operations of the method 1400 may be rearranged or otherwise modified such that other implementations are possible.

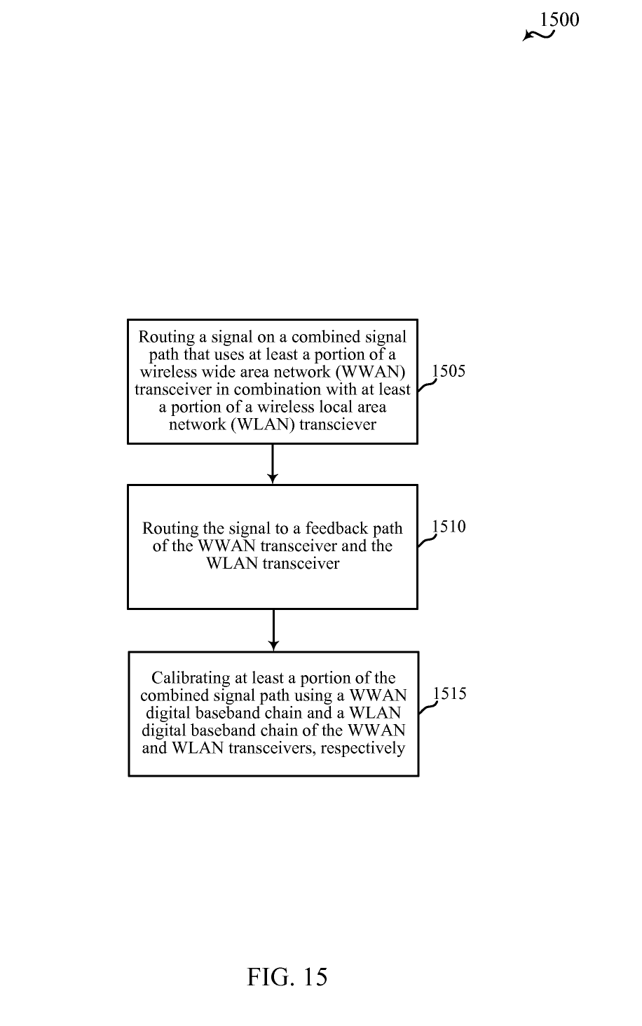

FIG. 15 is a flow chart illustrating an example of a method 1500 for wireless communication, in accordance with various aspects of the present disclosure. For clarity, the method 1500 is described below with reference to aspects of one or more of the UEs 115 described with reference to FIGS. 1 and 12, aspects of one or more of the systems described with reference to FIGS. 2-4 and 7-9, and/or aspects of one or more of the apparatuses described with reference to FIGS. 10 and 11. In some examples, a UE 115 may execute one or more sets of codes to control the functional elements of the UE 115 to perform the functions described below. Additionally or alternatively, the UE 115 may perform one or more of the functions described below using-purpose hardware.

At block 1505, the method 1500 may include routing a signal on a combined signal path that uses at least a portion of a WWAN transceiver in combination with at least a portion of a WLAN transceiver. The combined signal path may be either a combined Tx signal path or a combined Rx signal path.

The operations at block 1505 may be performed using at least the combined Tx signal path module 1105 and/or the combined Rx signal path module 1110 described with reference to FIG. 11.

At block 1510, the method 1500 may include routing the signal to a feedback path of the WWAN transceiver and the WLAN transceiver. Thus, calibration may occur using both a WWAN feedback path or a WLAN feedback path.

The operations at block 1510 may be performed using at least the WWAN feedback path module 1115 and/or the WLAN feedback path module 1120 described with reference to FIG. 11.

At block 1515, the method 1500 may include calibrating at least a portion of the combined signal path using a WWAN digital baseband chain and a WLAN digital baseband chain of the WWAN and WLAN transceivers, respectively. Thus, calibration may occur using both a WWAN feedback path and a WLAN feedback path. Calibration may occur online or in a factory (using a separate calibration unit, such as a test jig). Calibration may be accomplished using couplers and switches, over-the-air, or via cabling to route the signal from the combined signal path to both a WWAN feedback path and a WLAN feedback path.

The operations at block 1515 may be performed using at least the combined feedback calibration module 1125 described with reference to FIG. 11.

Thus, the method 1500 may provide for wireless communication. It should be noted that the method 1500 is just one implementation and that the operations of the method 1500 may be rearranged or otherwise modified such that other implementations are possible.

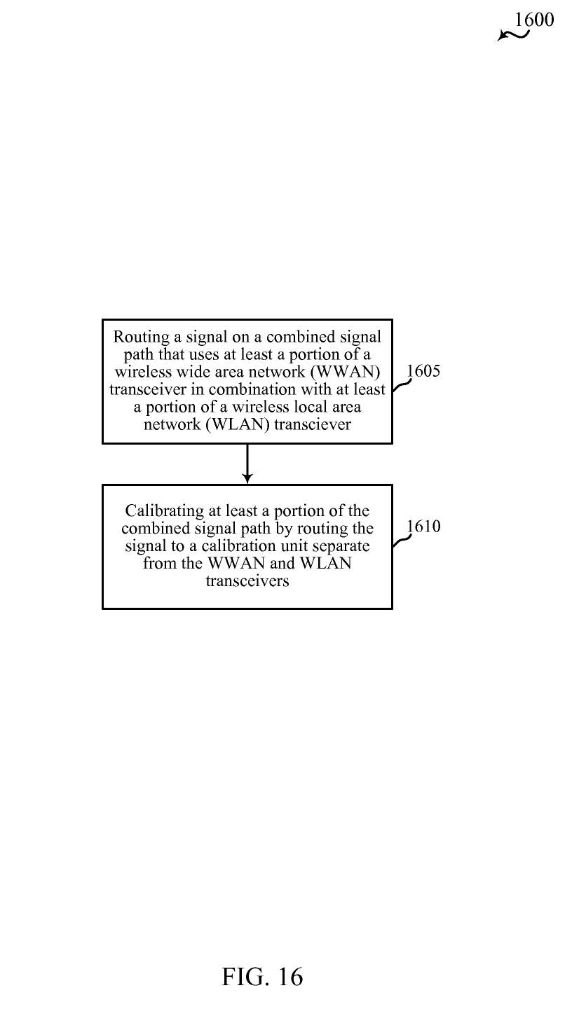

FIG. 16 is a flow chart illustrating an example of a method 1600 for wireless communication, in accordance with various aspects of the present disclosure. For clarity, the method 1600 is described below with reference to aspects of one or more of the UEs 115 described with reference to FIGS. 1 and 12, aspects of one or more of the systems described with reference to FIGS. 2-9, and/or aspects of one or more of the apparatuses described with reference to FIGS. 10 and 11. In some examples, a UE 115 may execute one or more sets of codes to control the functional elements of the UE 115 to perform the functions described below. Additionally or alternatively, the UE 115 may perform one or more of the functions described below using-purpose hardware.

At block 1605, the method 1600 may include routing a signal on a combined signal path that uses at least a portion of a WWAN transceiver in combination with at least a portion of a WLAN transceiver. The combined signal path may be either a combined Tx signal path or a combined Rx signal path.

The operations at block 1605 may be performed using at least the combined Tx signal path module 1105 and/or the combined Rx signal path module 1110 described with reference to FIG. 11.

At block 1610, the method 1600 may include calibrating at least a portion of the combined signal path by routing the signal to a calibration unit separate from the WWAN and WLAN transceivers. Calibration may occur using either a WWAN feedback path or a WLAN feedback path or both. Calibration may in a factory, for example, where the separate calibration unit may be a test jig.

The operations at block 1610 may be performed using at least the WWAN feedback path module 1115, the WLAN feedback path module 1120, and/or the combined feedback calibration module 1125 described with reference to FIG. 11.

Thus, the method 1600 may provide for wireless communication. It should be noted that the method 1600 is just one implementation and that the operations of the method 1600 may be rearranged or otherwise modified such that other implementations are possible.

In some examples, aspects from two or more of the methods 1300, 1400, 1500, 1600 may be combined. It should be noted that the methods 1300, 1400, 1500, 1600 are just example implementations, and that the operations of the methods 1300-1600 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. These may be examples of non-transitory computer-readable mediums. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
routing a signal on a combined signal path that uses at least a portion of a wireless wide area network (WWAN) transceiver in combination with at least a portion of a wireless local area network (WLAN) transceiver; and
calibrating at least a portion of the combined signal path.

2. The method of claim 1, wherein the combined signal path is one of a combined transmission signal path or a combined receive signal path.

3. The method of claim 1, wherein the combined signal path is a combined transmission signal path and a combined receive signal path.

4. The method of claim 1, wherein calibrating at least the portion of the combined signal path further comprises:
routing the signal to a feedback path of either the WWAN transceiver or the WLAN transceiver.

5. The method of claim 1, wherein calibrating at least the portion of the combined signal path further comprises:
routing the signal to a feedback path of the WWAN transceiver and a feedback path of the WLAN transceiver.

6. The method of claim 1, wherein calibrating at least the portion of the combined signal path further comprises:
routing the signal to a calibration unit.

7. The method of claim 1, wherein calibrating at least the portion of the combined signal path further comprises:
calibrating a plurality of combined signal paths that each use portions of the WWAN transceiver in combination with portions of the WLAN transceiver.

8. The method of claim 1, wherein calibrating at least the portion of the combined signal path further comprises:
routing the signal to a plurality of feedback paths corresponding to a plurality of receive chains associated with either the WWAN or the WLAN transceiver.

9. The method of claim 1, wherein the combined signal path includes at least portions of a digital baseband chain and analog baseband chain of the WWAN transceiver and at least portions of an analog radio frequency (RF) chain of the WLAN transceiver.

10. The method of claim 9, wherein calibrating at least the portion of the combined signal path further comprises:
connecting an output of the combined signal path with a feedback path of the WLAN transceiver; and
using the feedback path of the WLAN transceiver.

11. The method of claim 9, wherein calibrating at least the portion of the combined signal path further comprises:
calibrating the combined signal path at a WLAN digital baseband chain.

12. The method of claim 9, wherein calibrating at least the portion of the combined signal path further comprises:
connecting an output of the combined signal path with a feedback path of the WWAN transceiver; and
using the feedback path of the WWAN transceiver.

13. The method of claim 9, wherein calibrating at least the portion of the combined signal path further comprises:
calibrating the combined signal path at the WWAN digital baseband chain.

14. The method of claim 9, wherein calibrating at least the portion of the combined signal path further comprises:
connecting an output of the combined signal path with a feedback path of the WLAN transceiver;
connecting the output of the combined signal path with a feedback path of the WWAN transceiver; and
using the feedback paths of the WWAN transceiver and of the WLAN transceiver.

15. The method of claim 9, further comprising:
calibrating at least the portion of the combined signal path at the WWAN digital baseband chain and at a WLAN digital baseband chain.

16. The method of claim 9, wherein calibrating the combined signal path further comprises:
receiving the signal at either the WWAN transceiver or the WLAN transceiver after an over the air transmission of the signal; and
using the feedback paths of either the WWAN transceiver or the WLAN transceiver.

17. The method of claim 9, wherein calibrating at least the portion of the combined signal path further comprises:
receiving the signal at the WWAN transceiver and the WLAN transceiver after an over the air transmission of the signal; and
using the feedback paths of the WWAN transceiver and the WLAN transceiver.

18. The method of claim 9, wherein calibrating at least the portion of the combined signal path further comprises:
receiving the signal at either the WWAN transceiver or the WLAN transceiver via a cable crossover from an output of the combined signal path to either an input of the WWAN transceiver or an input of the WLAN transceiver; and
using the feedback path of either the WWAN transceiver or the WLAN transceiver.

19. The method of claim 9, wherein calibrating at least the portion of the combined signal path further comprises:
receiving the signal at the WWAN transceiver and the WLAN transceiver via a cable from an output of the combined signal path to an input of the WWAN transceiver and an input of the WLAN transceiver; and
using the feedback path of the WWAN transceiver and the WLAN transceiver.

20. The method of claim 1, wherein the combined signal path includes at least portions of a digital baseband chain and analog baseband chain of the WLAN transceiver and at least portions of an analog radio frequency (RF) chain of the WWAN transceiver.

21. The method of claim 1, wherein calibrating at least the portion of the combined signal path further comprises:
calibrating at least portions of a plurality of combined signal paths that each use portions of the WWAN transceiver in combination with portions of the WLAN transceiver,
wherein at least a first one of the plurality of combined signal paths includes at least portions of a digital baseband chain and analog baseband chain of the WWAN transceiver and at least portions of an analog radio frequency (RF) chain of the WLAN transceiver, and at least a second one of the plurality of combined signal paths includes at least portions of a digital baseband chain and analog baseband chain of the WLAN transceiver and at least portions of an analog RF chain of the WWAN transceiver.

22. The method of claim 1, wherein calibrating at least the portion of the combined signal path further comprises:
routing the signal to one or more feedback paths of the WWAN transceiver; and
routing the signal to one or more feedback paths of the WLAN transceiver.

23. An apparatus for wireless communication, comprising:
means for routing a signal on a combined signal path that uses at least a portion of a wireless wide area network (WWAN) transceiver in combination with at least a portion of a wireless local area network (WLAN) transceiver; and
means for calibrating at least a portion of the combined signal path.

24. The apparatus of claim 23, wherein the means for calibrating at least the portion of the combined signal path further comprises:
means for routing the signal to a feedback path of either the WWAN transceiver or the WLAN transceiver.

25. The apparatus of claim 23, wherein the means for calibrating at least the portion of the combined signal path further comprises:
means for routing the signal to a feedback path of the WWAN transceiver and a feedback path of the WLAN transceiver.

26. The apparatus of claim 23, wherein the means for calibrating at least the portion of the combined signal path further comprises:
means for routing the signal to a calibration unit.

27. The apparatus of claim 23, wherein the means for calibrating at least the portion of the combined signal path further comprises:
means for calibrating a plurality of combined signal paths that each use portions of the WWAN transceiver in combination with portions of the WLAN transceiver.

28. The apparatus of claim 23, wherein the means for calibrating at least the portion of the combined signal path further comprises:
means for routing the signal to a plurality of feedback paths corresponding to a plurality of receive chains associated with either the WWAN or the WLAN transceiver.

29. An apparatus for wireless communication, comprising:
a processor;
memory in electronic communication with the processor; and
instructions stored in the memory, the instructions being executable by the processor to:
route a signal on a combined signal path that uses at least a portion of a wireless wide area network (WWAN) transceiver in combination with at least a portion of a wireless local area network (WLAN) transceiver; and
calibrate at least a portion of the combined signal path.

30. A non-transitory computer-readable medium storing computer-executable code for wireless communication, the code executable by a processor to:
route a signal on a combined signal path that uses at least a portion of a wireless wide area network (WWAN) transceiver in combination with at least a portion of a wireless local area network (WLAN) transceiver; and
calibrate at least a portion of the combined signal path.
